(19) United States
(12) Patent Application Publication
(10) Pub. No.: US 2018/0147119 A1
(43) Pub. Date: May 31, 2018

(54) Robotic Capsule Filling Machine System

(71) Applicant: The Capsule Group, Inc., Pompano Beach, FL (US)

(72) Inventors: Jonathan Gilinski, Pompano Beach, FL (US); Eli Elias, Brooklyn, NY (US)

(73) Assignee: The Capsule Group, Inc., Pompano Beach, FL (US)

(21) Appl. No.: 15/363,196

(22) Filed: Nov. 29, 2016

(51) Int. Cl. A61J 3/07; B65B 3/04; B65B 3/30; A61J 1/16; B65B 1/04; B65B 1/36; B65B 57/14; B65B 7/28; B25J 9/16

(52) U.S. Cl. CPC A61J 3/074; B65B 3/04; B65B 3/30; A61J 1/16; B25J 9/1692; B65B 1/36; B65B 57/145; B65B 7/28; B65B 1/04

(57) ABSTRACT

A robotic capsule filling machine system is disclosed. In particular, the system may include a robotic capsule filling machine that is controlled by a computing device, such as a tablet. An application executing on the computing device may be utilized by a user to create a capsule formulation to be dispensed in capsules to be filled by the robotic capsule filling machine. Various inputs into the application may include, but are not limited to, a capsule size, a purity, a density, and a batch size. Based on the inputs, the system may translate the inputs to determine the desired capsule formulation. If the capsule formulation is valid, the system may cause the robotic capsule filling machine to extract an amount of the capsule formulation from one or more reservoirs. The robotic capsule filling machine may then proceed to dispense the extracted amount of capsule formulation into a plurality of capsules.

### FIELD OF THE INVENTION

The present application relates to robotic technologies, capsule filling technologies, and computing technologies, and more particularly, to a robotic capsule filling machine system.

### BACKGROUND

Despite today's rapidly advancing technological environment, capsule filling has remained a very complex, tedious, and arduous process. For example, traditional capsule filling technologies and processes often require having multiple chemists and formulators to be on site to set up proper capsule formulations and master mix concentrations for capsules to be filled. In certain instances, chemists must manually use a syringe or other dispensing device to carefully dispense formulated amounts of liquid or other substances into each capsule that is to be filled. Also, skilled and trained personnel must man such traditional capsule filling machines at all times and need to ensure that various state or other regulations are adhered to during the capsule filling process. Furthermore, such skilled and trained personnel are often in short supply and obtaining access to such professionals is often limited.

While various types of capsule filling machines exist today, such capsule filling machines still have many shortcomings. For example, such capsule filling machines typically operate based on a single-fixed-dispense basis. This means that these machines are only programmed to dispense a predetermined amount of liquid or other substance into a given capsule position. Additionally, existing capsule filling machines still typically require the use of chemists or other personnel to continuously monitor such capsule filling machines, particularly while such machines are in an operational mode. Furthermore, traditional capsule filling machines often utilize outdated air compressor technologies that tend to make the capsule filling process substantially more complex than necessary. Moreover, it is often quite difficult to switch from using one capsule formulation to another capsule formulation when using currently existing capsule filling machines. As a result, current capsule filling technologies and processes may be modified and improved so as to provide enhanced functionality and features for users and companies. Such enhancements and improvements to capsule filling technologies and processes may provide for improved machine operator satisfaction, improved customer satisfaction, increased product quality, and increased ease-of-use.

### SUMMARY

A robotic capsule filling machine system, apparatus, and accompanying methods are disclosed. In particular, the system, apparatus, and accompanying methods serve to provide a robotic capsule filling machine with accompanying software that interact with one another to allow for the production of accurately and consistently-dosed capsules. To that end, the operative functions of the robotic capsule filling machine may be controlled by an application that executes on a computing device, such as a tablet. The application may allow one or more users, such as machine operators, to easily create, customize, store, and switch between various capsule formulations of their choosing. For example, the application may allow for the creation, loading, validation, and storing of many different capsule formulations, which may minimize the risk for errors and reduce the amount of time to execute a capsule filling process.

The users utilizing the application and the computing device may be allowed to select a variety of modes for operating the robotic capsule filling machine. For example, the application may allow the user to select an option to operate the robotic capsule filling machine in a simple mode or in an advanced mode so as to accurately dose capsules. While in simple mode, the robotic capsule filling machine system, apparatus, and accompanying methods may be utilized to calculate the quantity of material (e.g. active ingredients and/or other ingredients) that is needed for a capsule formulation in order to fill the desired amount of capsules at an appropriate dosage. The robotic capsule filling machine system may take into account various factors, such as, but not limited to, density, gravity, and machine loss so as to ensure an accurate dispense of the capsule formulation into each of the capsules that need to be produced. If the user selects an option to operate the robotic capsule filling machine in an advanced mode, the robotic capsule filling machine system may transmit one or more signals to the robotic capsule filling machine to dispense a certain concentration of fill material into each of the capsules to be produced.

Furthermore, the robotic capsule filling machine system, apparatus, and methods may allow for the dispensing of both fixed and interval volume fill amounts into one or more capsules, and also allow for the accounting of the specific concentration of ingredients to be dispensed within a capsule itself. For example, the robotic capsule filling machine system may account for the amount of active ingredient necessary per capsule to reach the desired dosage, and may then formulate the capsule formulation according to the amount of excipient oil necessary to fill each capsule. Notably, traditional capsule filling machines simply dispense a given amount of volume into a capsule and do not account for the specific amounts of active ingredients or material in a capsule formulation. In contrast, the robotic capsule filling machine system described in the present disclosure accounts for the specific amounts of active ingredients or material in a capsule formulation and also allows a user to utilize the robotic capsule filling machine to pull multiple different materials from multiple reservoirs, which may then be dispensed into capsules in predetermined quantities. Based on the functionality provided by the robotic capsule filling machine system, apparatus, and methods, capsule filling is no longer a complex and arduous process. Additionally, chemists and formulators are no longer required to set up the proper capsule formulations and master mix concentrations. As a result, the robotic capsule filling machine system, apparatus, and methods provide improvements and enhancements to capsule filling technologies and processes, and provide for improved machine operator satisfaction, improved customer satisfaction, increased product quality, and increased ease-of-use.

In one embodiment, a robotic capsule filling machine apparatus is disclosed. The apparatus may include a robotic capsule filling machine that includes a robotic arm, a capsule tray, a reservoir, and various other components. The apparatus may also include a computing device that may be utilized to control the robotic capsule filling machine. The computing device may include a memory that stores instructions and a processor that executes the instructions to perform various operations of the computing device, such as operations used to control the robotic capsule filling machine. In certain embodiments, the computing device may be configured to receive, such as via an interface of an application executing on the computing device, one or more inputs corresponding to a capsule formulation. In certain embodiments, the inputs may include, but are not limited to, a capsule size input, a dosage input, a purity input, a density input, and a batch size input. Upon receiving the inputs via the interface, the computing device may translate the inputs to determine a capsule formulation corresponding to the inputs. Based on the capsule formulation and the inputs, the computing device may proceed to determine an amount of the capsule formulation to be dispensed into each capsule of a plurality of capsules corresponding to the batch size input received by the computing device. The computing device may then transmit a signal to cause the robotic arm of the robotic capsule filling machine to extract the amount of the capsule formulation for each capsule of the plurality of capsules from the reservoir of the robotic capsule filling machine. Based on the signal, the robotic arm of the robotic capsule filling machine may proceed to dispense the amount of the capsule formulation into each capsule of the plurality of capsules. The capsules may then be sealed and packaged as desired.

In another embodiment, a method for utilizing a robotic capsule filling machine to fill capsules is disclosed. The method may include utilizing a memory that stores instructions, and a processor that executes the instructions to perform the various functions of the method. In particular, the method may include receiving, such as via an interface of an application executing on a computing device, a plurality of inputs corresponding to a capsule formulation. The plurality of inputs may include, but are not limited to, a capsule size input, a dosage input, a purity input, a density input, and a batch size input. The method may then include translating the received inputs to determine the capsule formulation corresponding to the inputs. Additionally, the method may include determining, based on the capsule formulation and the inputs, an amount of the capsule formulation to be dispensed into each capsule of a plurality of capsules corresponding to the batch size input. Furthermore, the method may include transmitting, to the robotic capsule filling machine, a signal to cause a robotic arm of the robotic capsule filling machine to extract the amount of the capsule formulation for each capsule of the plurality of capsules from a reservoir of the robotic capsule filling machine. Moreover, the method may include causing, based on the signal and after the robotic arm of the robotic capsule filling machine extracts the amount of the capsule formulation from the reservoir, the robotic arm to dispense the amount of the capsule formulation into each capsule of the plurality of capsules.

According to yet another embodiment, a computer-readable device having instructions for providing a robotic capsule filling machine system is provided. The computer instructions, which when loaded and executed by a processor, may cause the processor to perform operations including: receiving, via an interface of an application executing on a computing device, a plurality of inputs corresponding to a capsule formulation, wherein the plurality of inputs comprise a capsule size input, a dosage input, a purity input, a density input, and a batch size input; translating the inputs to determine the capsule formulation; determining, based on the capsule formulation and the inputs, an amount of the capsule formulation to be dispensed into each capsule of a plurality of capsules corresponding to the batch size input; transmitting, to a robotic capsule filling machine, a signal to cause a robotic arm of the robotic capsule filling machine to extract the amount of the capsule formulation for each capsule of the plurality of capsules from a reservoir of the robotic capsule filling machine; and causing, based on the signal and after the robotic arm of the robotic capsule filling machine extracts the amount of the capsule formulation from the reservoir, the robotic arm to dispense the amount of the capsule formulation into each capsule of the plurality of capsules.

These and other features of the apparatuses, systems, and methods for providing a robotic capsule filling machine system are described in the following detailed description, drawings, and appended claims.

### BRIEF DESCRIPTION OF THE DRAWINGS

FIG. 1 is a schematic diagram of a robotic capsule filling machine system according to an embodiment of the present disclosure.

FIG. 2 is a diagram detailing various features of the robotic capsule filling machine of the robotic capsule filling machine system of FIG. 1.

FIG. 3 is a diagram detailing various internal features of the robotic capsule filling machine of the robotic capsule filling machine system of FIG. 1.

FIG. 4 is a diagram illustrating a capsule tray apparatus, a reservoir, and a tip pack tray of the robotic capsule filling machine system of FIG. 1.

FIG. 5 is a diagram illustrating a side view of the capsule tray apparatus of FIG. 4.

FIG. 6 is a diagram illustrating a view of a bed, a bed adaptor, a pair of reservoirs, and a tip pack tray of the robotic capsule filling machine of the robotic capsule filling machine system of FIG. 1.

FIG. 7 is a diagram illustrating a reservoir, a bed adaptor, and a tip pack tray adaptor of the robotic capsule filling machine of the robotic capsule filling machine system of FIG. 1.

FIG. 8 is a diagram illustrating a perspective view of a bed adaptor of the robotic capsule filling machine of the robotic capsule filling machine system of FIG. 1.

FIG. 9 is a diagram illustrating a side view of the bed adaptor of FIG. 8 when disconnected from the bed of the robotic capsule filling machine of the robotic capsule filling machine system of FIG. 1.

FIG. 10 is a diagram illustrating a top view of a tip pack adaptor affixed to a bed of the robotic capsule filling machine of the robotic capsule filling machine system of FIG. 1.

FIG. 11 is a diagram illustrating an angled perspective view of a tip pack tray of the robotic capsule filling machine of the robotic capsule filling machine system of FIG. 1.

FIG. 12 is a diagram illustrating a view of the interior of the robotic capsule filling machine of FIG. 1, which includes bottom halves of capsules positioned within capsule slots of a capsule tray apparatus of the robotic capsule filling machine and which illustrates the robotic arm of the capsule filling machine lowered in a position to extract an amount of a capsule formulation.

FIG. 13 is a diagram illustrating a view of the interior of the robotic capsule filling machine of FIG. 1, which includes bottom halves of capsules positioned within capsule slots of a capsule tray apparatus of the robotic capsule filling machine and which illustrates tips secured to the robotic arm of the capsule filling machine extracting an amount of a capsule formulation from a reservoir.

FIG. 14 is a diagram illustrating a front view of the robotic capsule filling machine of FIG. 1 with the robotic arm positioned over a capsule tray apparatus of the robotic capsule filling machine prior to dispensing capsule formulation into a plurality of capsules.

FIG. 15 is a diagram illustrating a front view of the robotic capsule filling machine of FIG. 1 depicting the robotic arm of the robotic capsule filling machine after dispensing capsule formulation into a plurality of capsules.

FIG. 16 is a diagram illustrating a close-up view of the tips of the robotic arm of the robotic capsule filling machine of FIG. 1 in the process of dispensing amounts of capsule formulation into a plurality of capsules.

FIG. 17 is a diagram illustrating another close-up view of the tips of the robotic arm of the robotic capsule filling machine of FIG. 1 in the process of dispensing amounts of capsule formulation into a plurality of capsules.

FIG. 18 is a diagram illustrating a user in the process of removing the capsule tray apparatus of the robotic capsule filling machine of FIG. 1 out of the robotic capsule filling machine.

FIG. 19 is a diagram illustrating a graphical user interface screen for allowing the selection of a capsule size of a capsule to be produced by the robotic capsule filling machine of the robotic capsule filling machine system of FIG. 1 while in a simple mode of operation.

FIG. 20 is a diagram illustrating a graphical user interface screen for allowing the selection of a dosage of a capsule to be produced by the robotic capsule filling machine of the robotic capsule filling machine system of FIG. 1 while in a simple mode of operation.

FIG. 21 is a diagram illustrating a graphical user interface screen for allowing the selection of a purity of an ingredient within a capsule to be produced by the robotic capsule filling machine of the robotic capsule filling machine system of FIG. 1 while in a simple mode of operation.

FIG. 22 is a diagram illustrating a graphical user interface screen for allowing the selection of a density associated with an ingredient to be included within a capsule to be produced by the robotic capsule filling machine of the robotic capsule filling machine system of FIG. 1 while in a simple mode of operation.

FIG. 23 is a diagram illustrating a graphical user interface screen for allowing the selection of a batch size of capsules to be produced by the robotic capsule filling machine of the robotic capsule filling machine system of FIG. 1 while in a simple mode of operation.

FIG. 24 is a diagram illustrating a graphical user interface screen displaying validation details associated with a capsule formulation for use by the robotic capsule filling machine of the robotic capsule filling machine system of FIG. 1 while in a simple mode of operation.

FIG. 25 is a diagram illustrating a graphical user interface screen for displaying a job status associated with the robotic capsule filling machine of the robotic capsule filling machine system of FIG. 1.

FIG. 26 is a diagram illustrating a graphical user interface screen displaying settings associated with an application that is utilized with the robotic capsule filling machine of the robotic capsule filling machine system of FIG. 1.

FIG. 27 is a diagram illustrating a graphical user interface screen for allowing the selection of a capsule size of capsules to be filled by the robotic capsule filling machine of the robotic capsule filling machine system of FIG. 1 while in an advanced mode of operation.

FIG. 28 is a diagram illustrating a graphical user interface screen for allowing the selection of a dispense volume of a capsule formulation for capsules to be filled by the robotic capsule filling machine of the robotic capsule filling machine system of FIG. 1 while in an advanced mode of operation.

FIG. 29 is a diagram illustrating a graphical user interface screen for allowing the selection of a batch volume for the capsule formulation to be utilized in the capsules to be filled by the robotic capsule filling machine of the robotic capsule filling machine system of FIG. 1 while in an advanced mode of operation.

FIG. 30 is a diagram illustrating a graphical user interface screen for allowing the selection of the amount of milligrams of active ingredient to be utilized in the capsule formulation to be utilized in the capsules to be filled by the robotic capsule filling machine of the robotic capsule filling machine system of FIG. 1 while in an advanced mode of operation.

FIG. 31 is a diagram illustrating a graphical user interface screen displaying validation details associated with a capsule formulation for use by the robotic capsule filling machine of the robotic capsule filling machine system of FIG. 1 while in an advanced mode of operation.

FIG. 32 is a diagram illustrating a graphical user interface screen for allowing the initiation of a job, the creation of a new capsule formulation, the loading of a capsule formulation, the saving of a capsule formulation, the loading of a history of capsule formulations generated by the robotic capsule filling machine of FIG. 1, a shopping cart feature, and various other features.

FIG. 33 is a diagram illustrating a graphical user interface of an application that allows for additional functionality as it relates to the robotic capsule filling machine system of FIG. 1.

FIG. 34 a diagram illustrating a graphical user interface of an application that allows for additional functionality as it relates to the robotic capsule filling machine system of FIG. 1.

FIG. 35 a diagram illustrating a graphical user interface of an application that allows for debug functionality as it relates to the robotic capsule filling machine system of FIG. 1.

FIG. 36 is a diagram illustrating a graphical user interface of an application that allows for loading a history of capsule formulations as it relates to the robotic capsule filling machine system of FIG. 1.

FIG. 37 is a diagram illustrating a graphical user interface of an application that allows for the loading of capsule formulations as it relates to the robotic capsule filling machine system of FIG. 1.

Figure is 38 a diagram illustrating a graphical user interface of an application that allows for various settings as it relates to the robotic capsule filling machine system of FIG. 1.

FIG. 39 a diagram illustrating a graphical user interface of an application that allows for various settings as it relates to the robotic capsule filling machine system of FIG. 1.

FIG. 40 is a flow diagram illustrating a sample method for utilizing a robotic capsule filling machine to fill capsules according to an embodiment of the present disclosure.

FIG. 41 is a schematic diagram of a machine in the form of a computer system within which a set of instructions, when executed, may cause the machine to perform any one or more of the methodologies or operations of the systems and methods for providing a robotic capsule filling machine system.

### DETAILED DESCRIPTION OF THE INVENTION

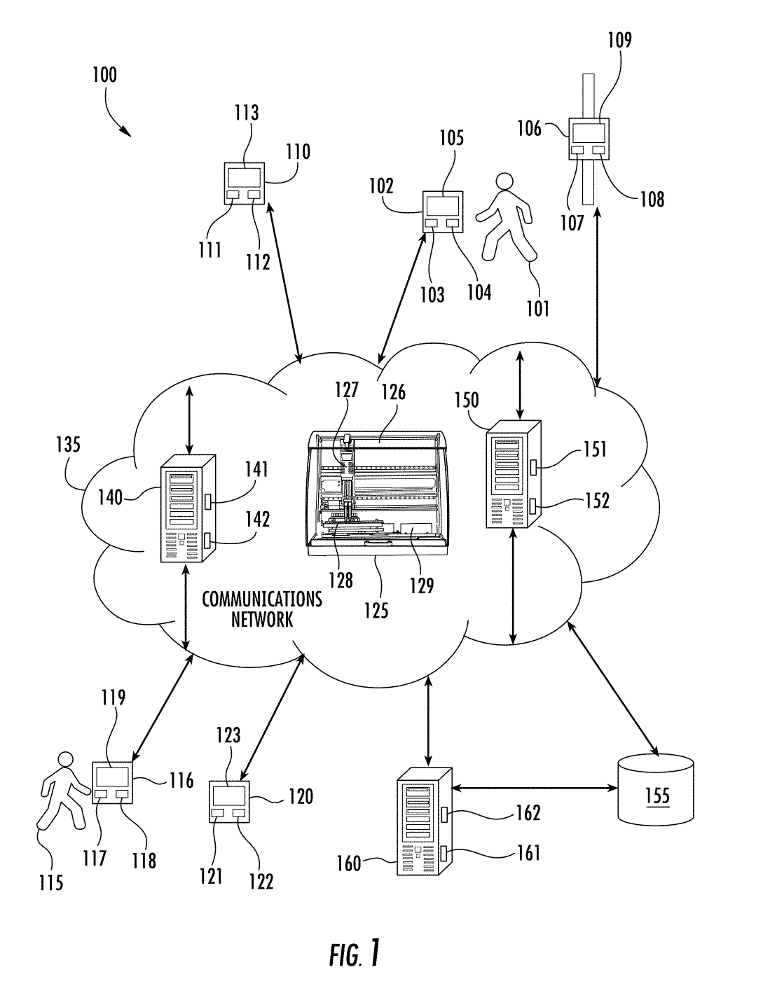

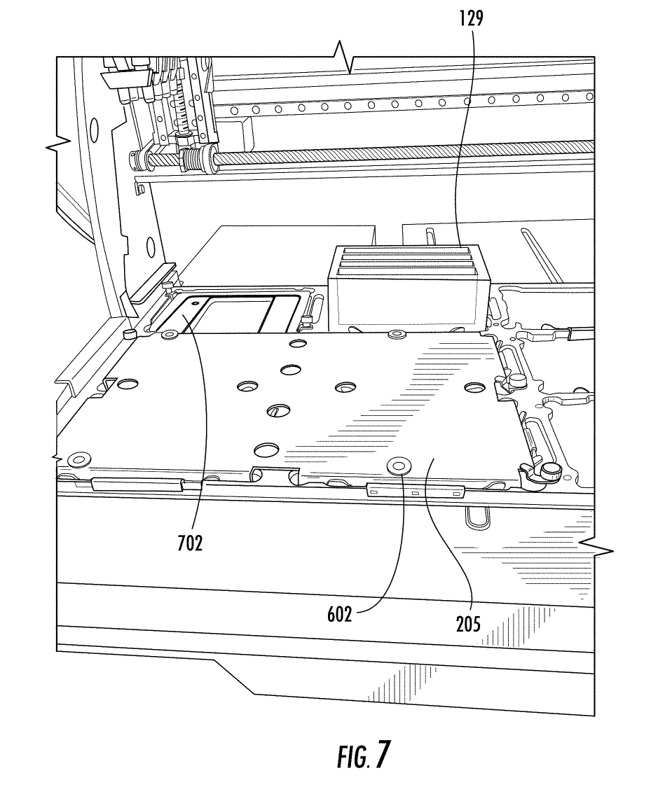

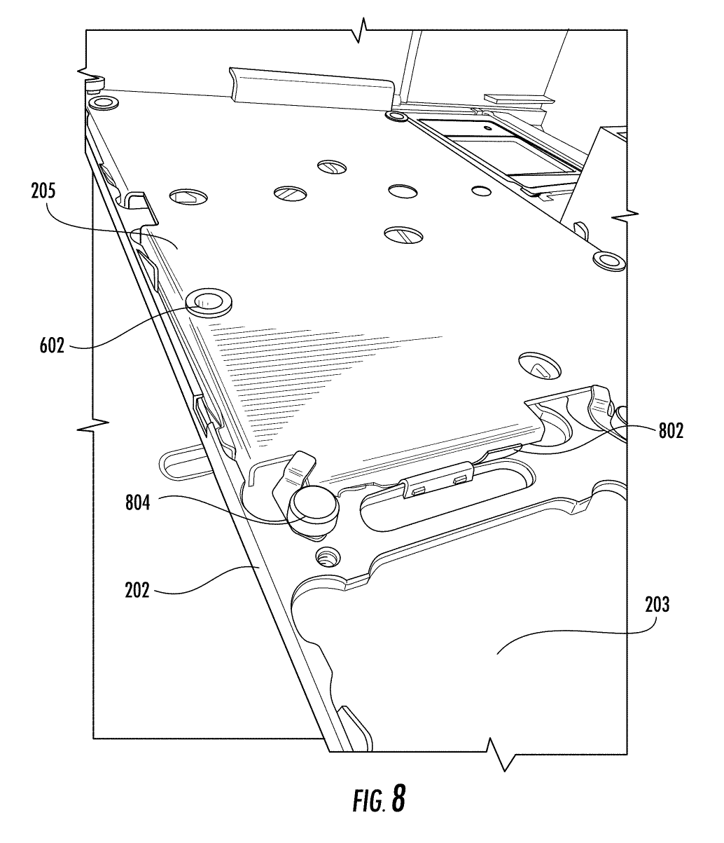

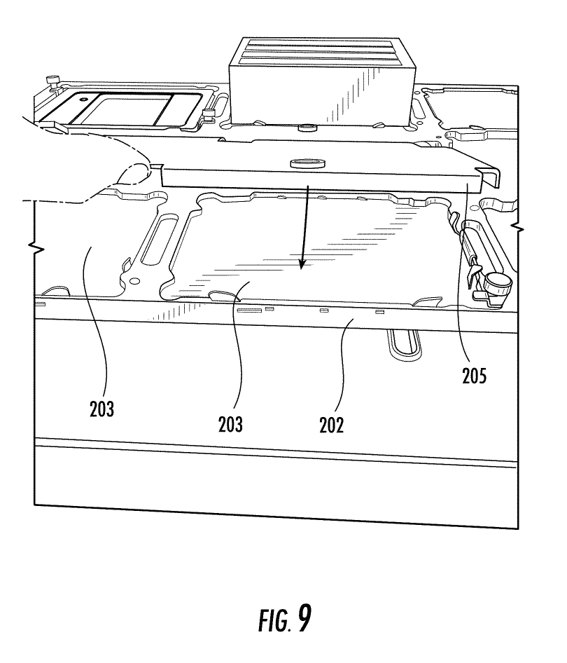

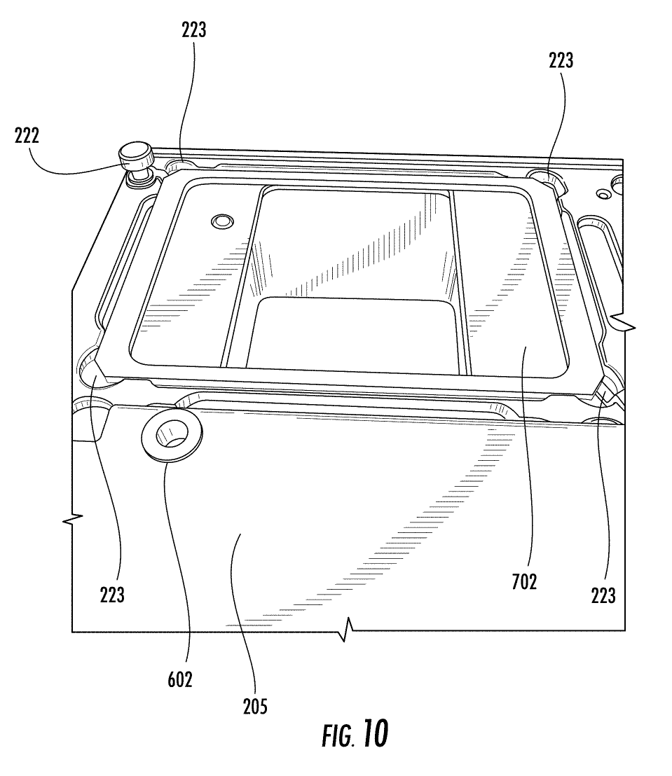

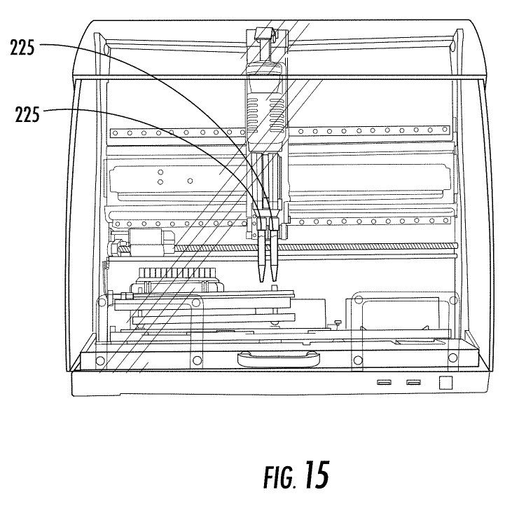

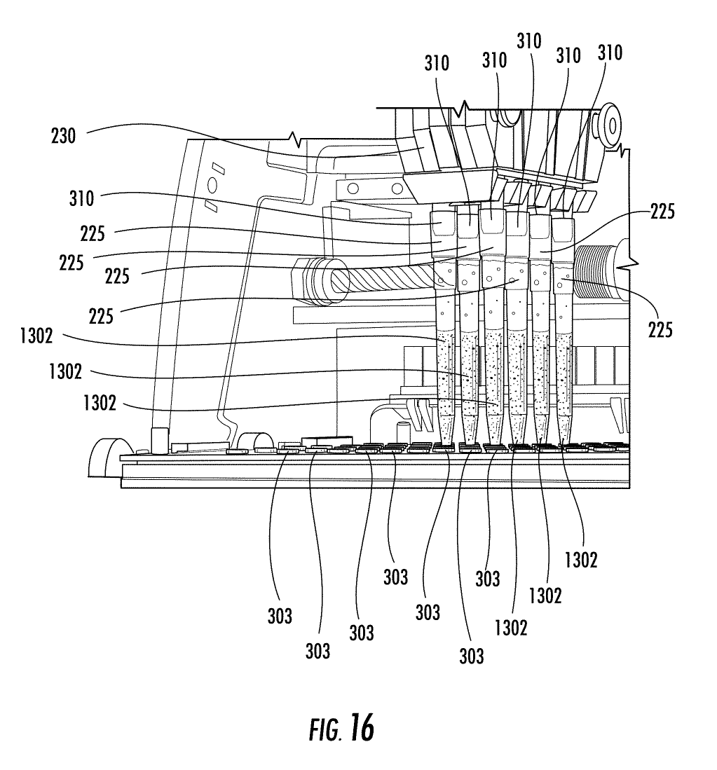

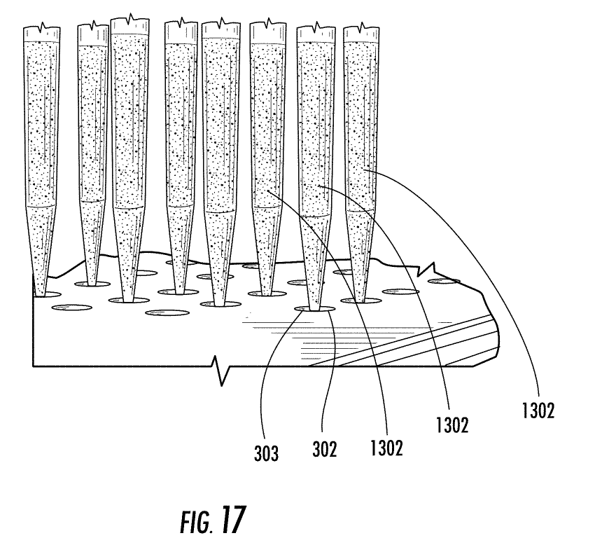

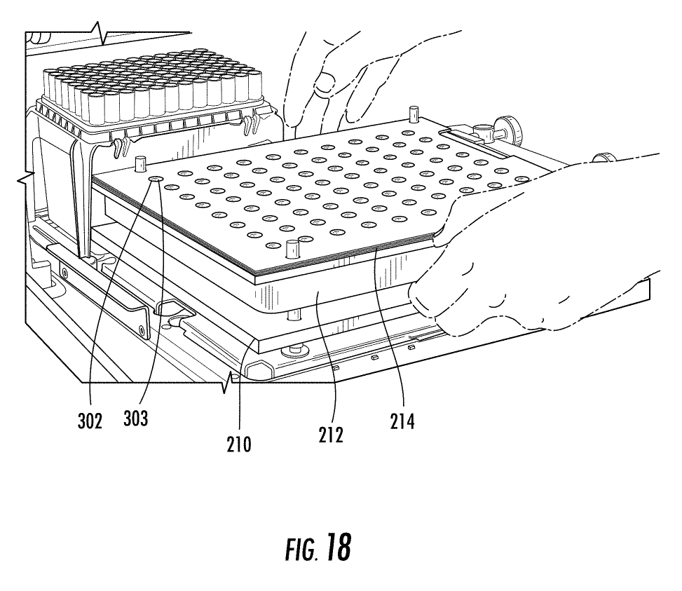

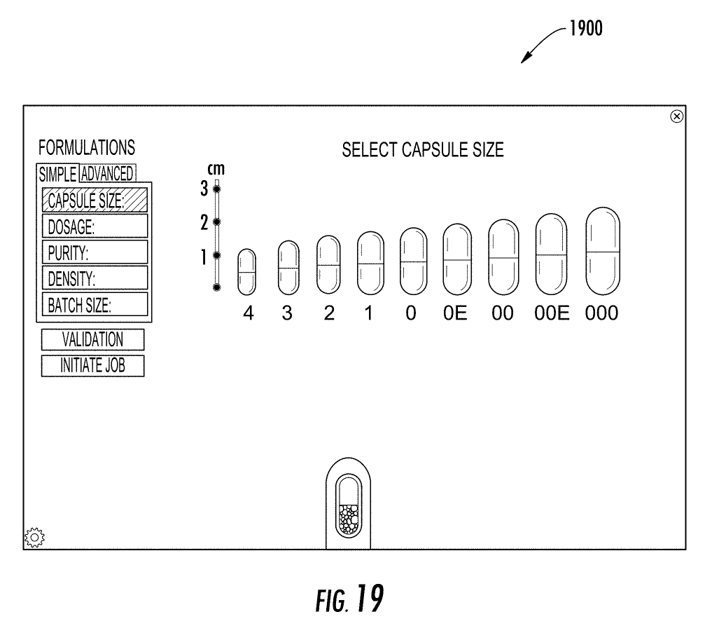

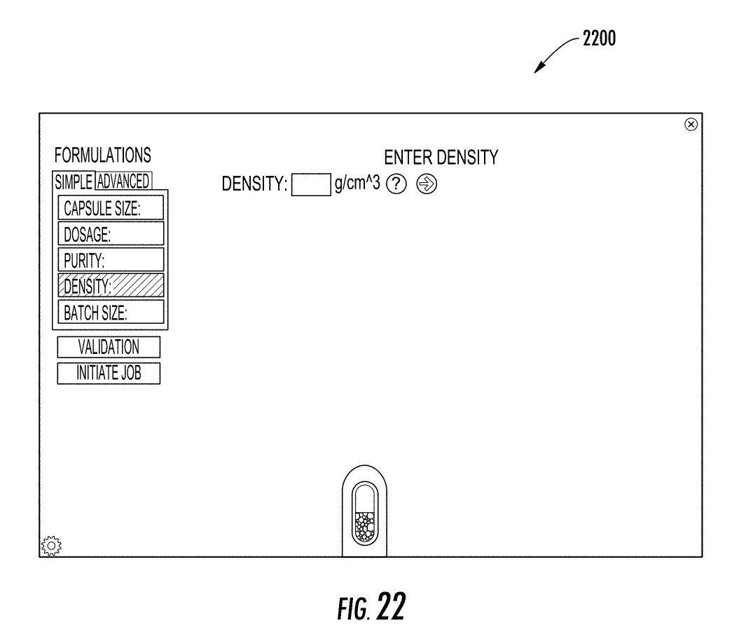

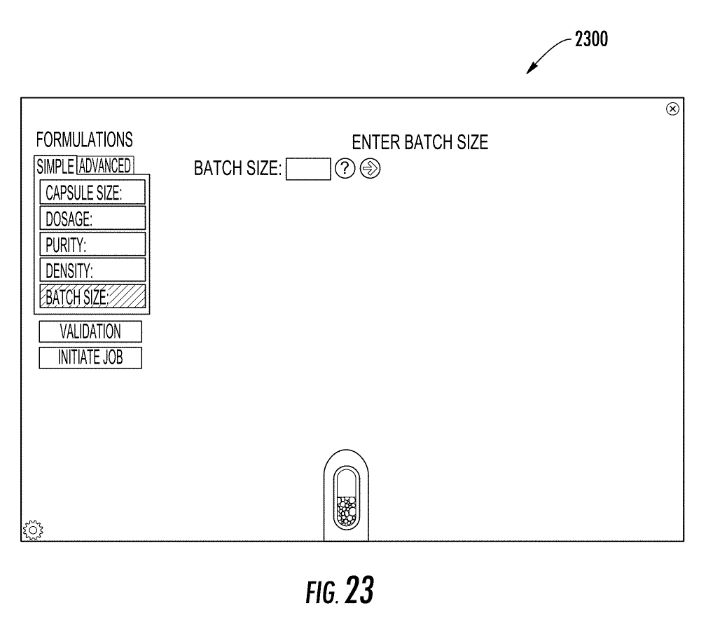

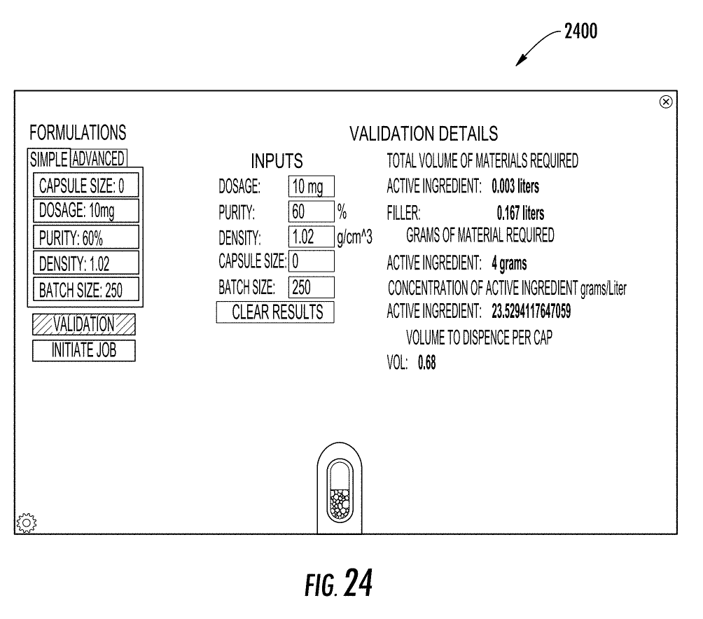

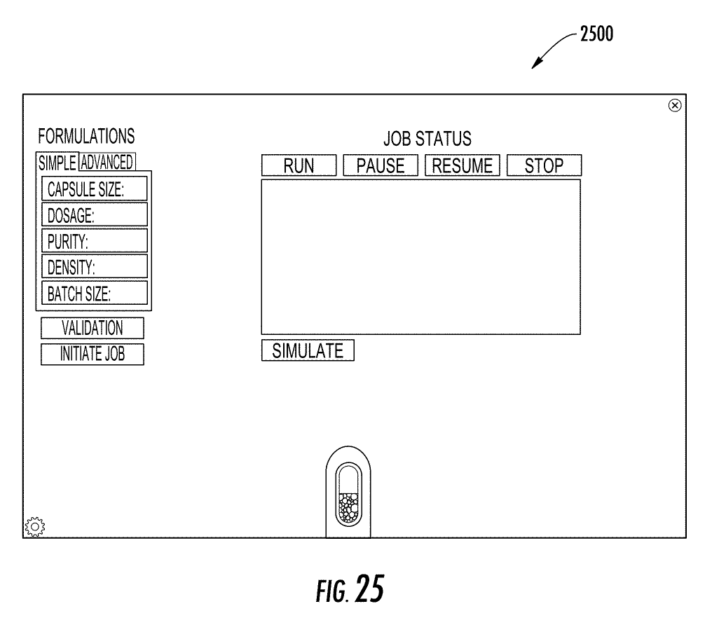

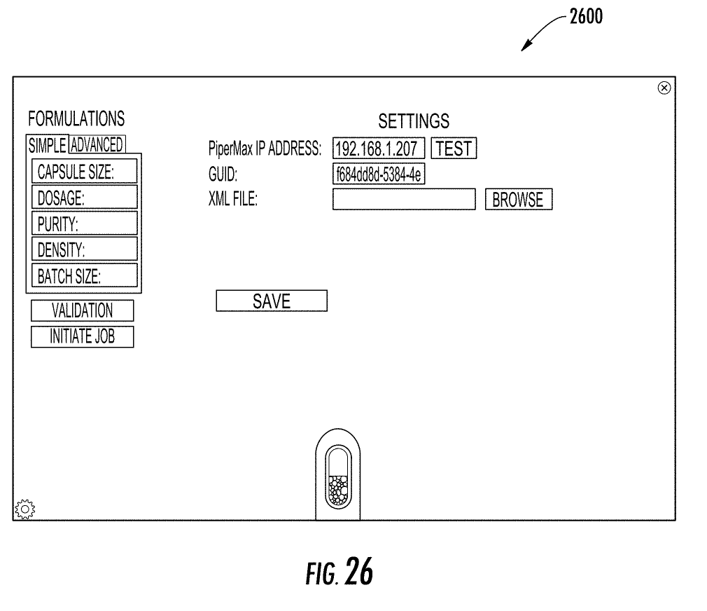

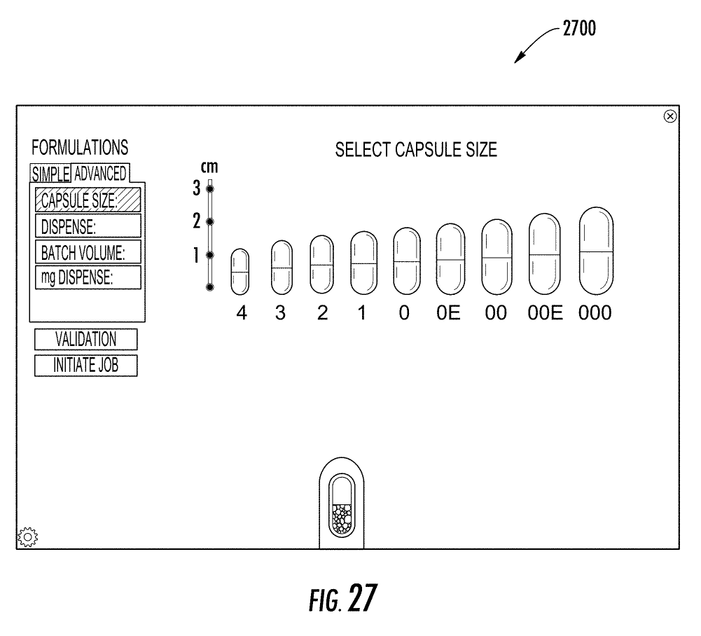

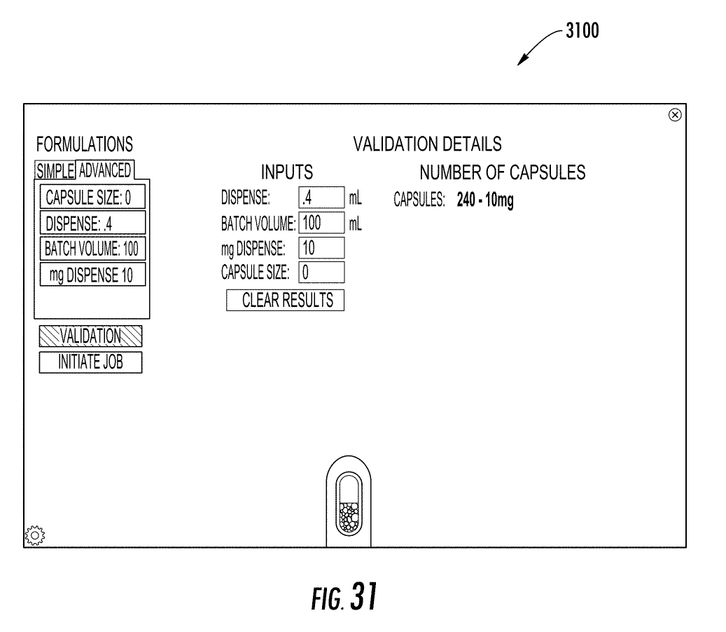

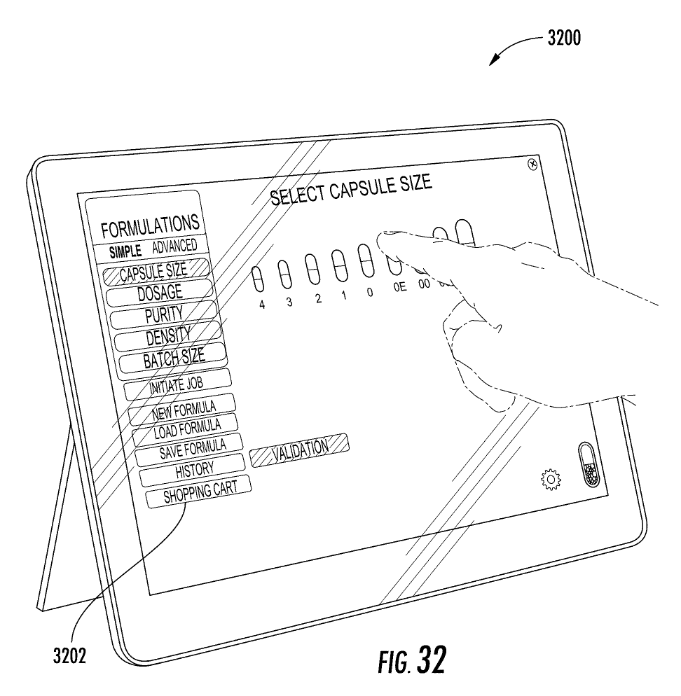

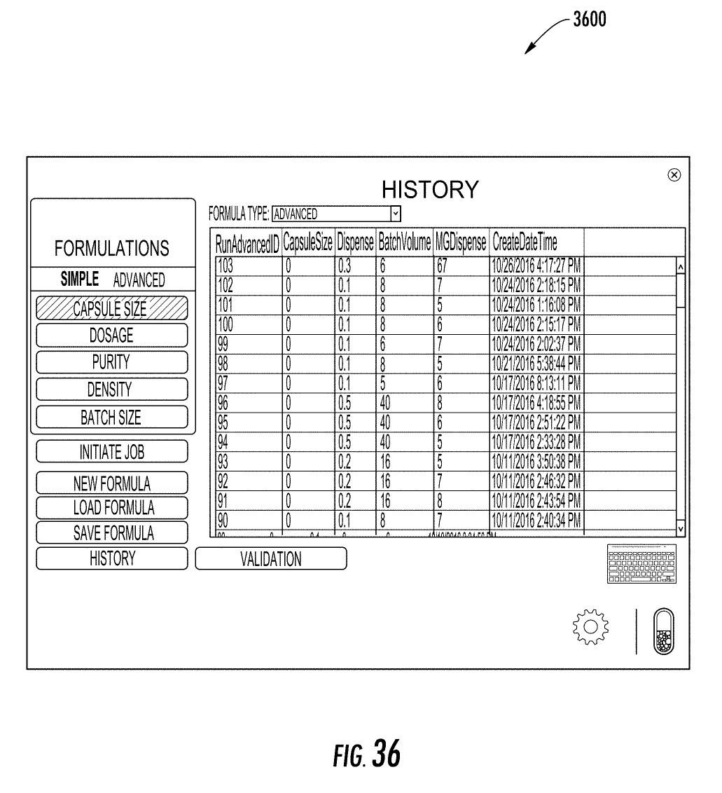

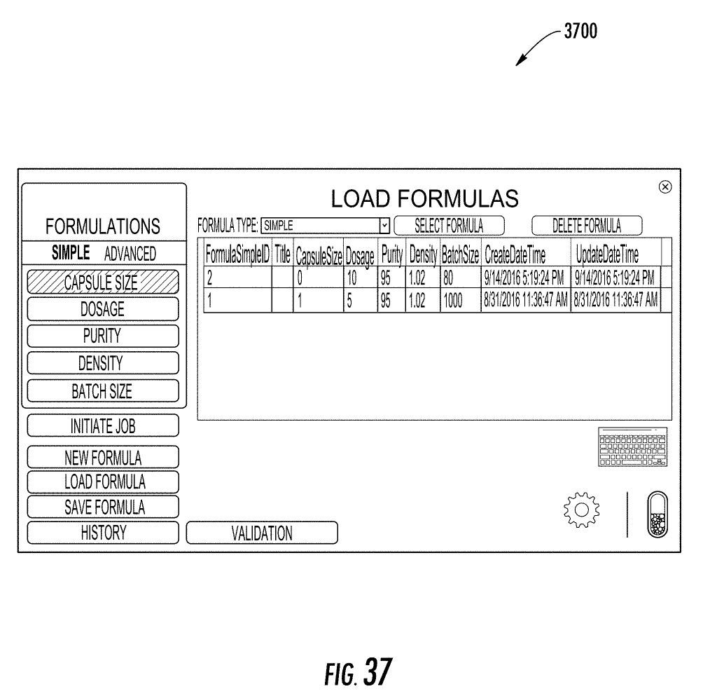

A robotic capsule filling machine system 100, apparatus, and accompanying methods are disclosed, as in shown in FIGS. 1-41. In particular, the system 100, apparatus, and accompanying methods provide a robotic capsule filling machine 125 controlled by software to allow for the production of accurately and consistently-dosed capsules. In order to do so, the operative functions of the robotic capsule filling machine 125 may be controlled by an application that executes on a computing device, such as a tablet. The application may allow one or more users, such as first and second users 101, 115, to easily create, customize, store, and switch between multiple capsule formulations. As an example, the application may allow for the creation, loading, validation, and storing of many different capsule formulations, which may minimize the risk for errors and reduce the amount of time to execute a capsule filling process. Additionally, the application may allow the users to order replacement parts and various components of the robotic capsule filling machine 125 directly via the application executing on the computing device. Furthermore, the application may allow the users to select an option to recalibrate the robotic capsule filling machine 125 of the robotic capsule filling machine system 100, view a history of capsule formulations executed by the robotic capsule filling machine system 100, enter into a debug mode, update software utilized with the robotic capsule filling machine 125, perform other actions, or a combination thereof.

The users utilizing the application and the computing device may be allowed to select a variety of modes for operating the robotic capsule filling machine 125. For example, the application may allow the user to select an option to operate the robotic capsule filling machine 125 in a simple mode or in an advanced mode so as to accurately dose capsules. While in simple mode, the robotic capsule filling machine system 100, apparatus, and accompanying methods may be utilized to calculate the quantity of material (e.g. active ingredients and/or other ingredients) that is needed for a capsule formulation in order to fill the desired amount of capsules at an appropriate dosage. The robotic capsule filling machine system 100 may take into account various factors, such as, but not limited to, density, gravity, and machine loss so as to ensure an accurate dispense of the capsule formulation into each of the capsules that need to be produced. If the user selects an option to operate the robotic capsule filling machine 125 in an advanced mode, the robotic capsule filling machine system 100 may transmit one or more signals to the robotic capsule filling machine 125 to dispense a certain concentration of fill material into each of the capsules to be produced.

Furthermore, the robotic capsule filling machine system 100, apparatus, and methods may allow for the dispensing of both fixed and interval volume fill amounts into one or more capsules, and also allow for the accounting of the specific concentration of ingredients to be dispensed within a capsule itself. As an example, the robotic capsule filling machine system 100 may account for the amount of active ingredient necessary per capsule to reach the desired dosage, and may then formulate the capsule formulation according to the amount of excipient oil necessary to fill each capsule. The robotic capsule filling machine system 100 accounts for the specific amounts of active ingredients or material in a capsule formulation and also allows a user to utilize the robotic capsule filling machine 125 to pull multiple different materials from multiple reservoirs, which may then be dispensed into capsules in predetermined quantities. Based on the functionality provided by the robotic capsule filling machine system 100, apparatus, and methods, capsule filling is no longer a complex and arduous process. Additionally, chemists and formulators are no longer required to set up the proper capsule formulations and master mix concentrations. Thus, the robotic capsule filling machine system 100, apparatus, and methods provide substantial improvements and enhancements to capsule filling technologies and processes. Moreover, the robotic capsule filling machine system 100, apparatus, and methods provide for improved machine operator satisfaction, improved customer satisfaction, increased product quality, and increased ease-of-use.

As shown in FIGS. 1-39, a robotic capsule filling machine system 100 (i.e. system 100) is disclosed. The system 100 may be configured to support, but is not limited to supporting, content delivery services, cloud computing services, satellite services, telephone services, voice-over-internet protocol services (VoIP), voice-over-long-term-evolution (VoLTE) services, software as a service (SaaS) applications, mobile applications and services, and any other computing applications and services. The system may include a first user 101, who may utilize a first user device 102 to access data, content, and applications, or to perform a variety of other tasks and functions. As an example, the first user 101 may utilize first user device 102 to access an application executing on the first user device 102 that may be utilized to control a robotic capsule filling machine 125. In certain embodiments, the first user 101 may be a machine operator, who may operate the robotic capsule filling machine 125 of the system 100. The first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be a computer, a laptop, a tablet device, a phablet, a server, a mobile device, a smartphone, a smart watch, and/or any other type of computing device. Illustratively, the first user device 102 is shown as a smartphone device in FIG. 1.

In addition to using first user device 102, the first user 101 may also utilize a second user device 106 and a third user device 110. As with first user device 102, the first user 101 may utilize the second and third user devices 106, 110 to access data, content, and applications, or to perform a variety of other tasks and functions. The second user device 106 may include a memory 107 that includes instructions, and a processor 108 that executes the instructions from the memory 107 to perform the various operations that are performed by the second user device 106. In certain embodiments, the processor 108 may be hardware, software, or a combination thereof. The second user device 106 may also include an interface 109 that may enable the first user 101 to interact with various applications executing on the second user device 106 and to interact with the system 100. In certain embodiments, the second user device 106 may be a computer, a laptop, a tablet device, a phablet, a server, a mobile device, a smartphone, a smart watch, and/or any other type of computing device. Illustratively, the second user device 102 is shown as a smart watch device in FIG. 1.

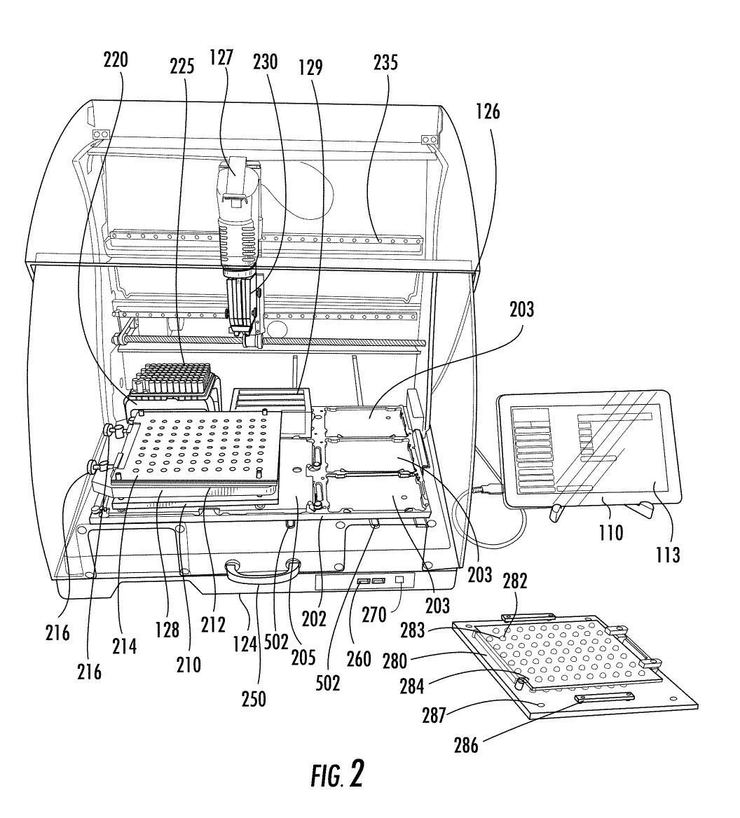

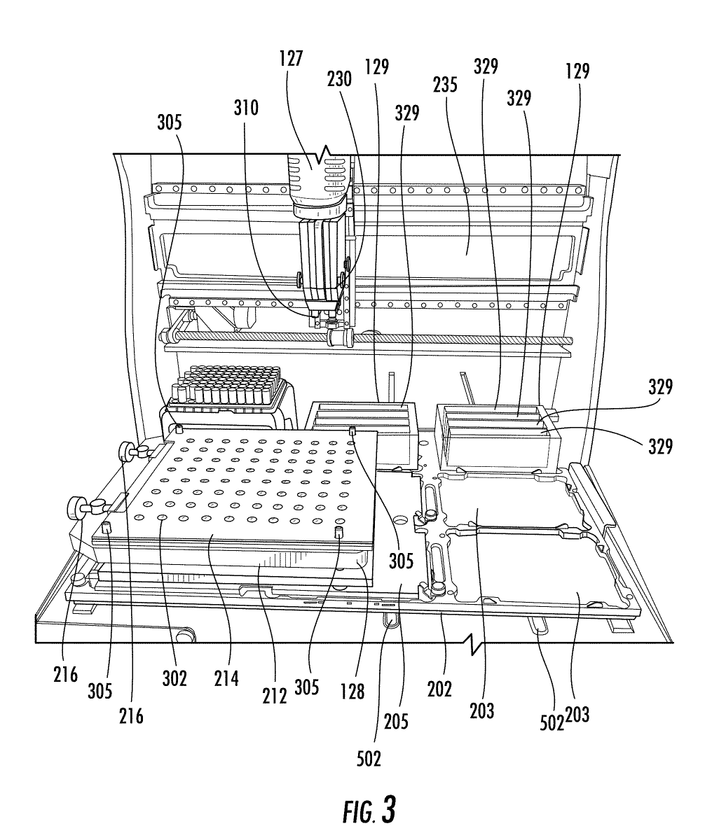

The third user device 110 may include a memory 111 that includes instructions, and a processor 112 that executes the instructions from the memory 111 to perform the various operations that are performed by the third user device 110. In certain embodiments, the processor 112 may be hardware, software, or a combination thereof. The third user device 110 may also include an interface 113 that may enable the first user 101 to interact with various applications executing on the third user device 110 and to interact with the system 100. In certain embodiments, the third user device 106 may be a computer, a laptop, a tablet device, a phablet, a server, a mobile device, a smartphone, a smart watch, and/or any other type of computing device. Illustratively, the third user device 110 is shown as a tablet device in FIGS. 1-2.

In addition to the first user 101, the system 100 may also include a second user 115, who may utilize a fourth user device 116 to perform a variety of functions, such as to control robotic capsule filling machine 125. For example, the fourth user device 116 may be utilized by the second user 115 to access data, content, and applications, or to perform a variety of other tasks and functions. The fourth user device 116 may include a memory 117 that includes instructions, and a processor 118 that executes the instructions from the memory 117 to perform the various operations that are performed by the fourth user device 116. In certain embodiments, the processor 118 may be hardware, software, or a combination thereof. The fourth user device 116 may also include an interface 119 (e.g. screen, monitor, graphical user interface, etc.) that may enable the second user 115 to interact with various applications executing on the fourth user device 116 and to interact with the system 100. In certain embodiments, the fourth user device 116 may be a computer, a laptop, a tablet device, a phablet, a server, a mobile device, a smartphone, a smart watch, and/or any other type of computing device. Illustratively, the fourth user device 116 is shown as a smartphone device in FIG. 1.

The second user 115 may also utilize a fifth user device 120 to perform a variety of functions, such as to control robotic capsule filling machine 125. As with the fourth user device 116, the fifth user device 120 may be utilized by the second user 115 to access data, content, and applications, or to perform a variety of other tasks and functions. The fifth user device 120 may include a memory 121 that includes instructions, and a processor 122 that executes the instructions from the memory 121 to perform the various operations that are performed by the fifth user device 120. In certain embodiments, the processor 122 may be hardware, software, or a combination thereof. The fifth user device 120 may also include an interface 123 (e.g. screen, monitor, graphical user interface, etc.) that may enable the second user 115 to interact with various applications executing on the fifth user device 120 and to interact with the system 100. In certain embodiments, the fifth user device 120 may be a computer, a laptop, a tablet device, a phablet, a server, a mobile device, a smartphone, a smart watch, and/or any other type of computing device. Illustratively, the fifth user device 120 is shown as a tablet device in FIG. 1.

In certain embodiments, the first user device 102, the second user device 106, the third user device 110, the fourth user device 116, and/or the fifth user device 120 may have any number of software applications and/or application services stored and/or accessible thereon. For example, the first, second, third, fourth, and fifth user devices 102, 106, 110, 116, 120 may include cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications and services may include one or more graphical user interfaces so as to enable the first and second users 101, 115 to readily interact with the software applications. Sample user interfaces for use with the system 100 are illustratively shown in FIGS. 19-39. The software applications and services may also be utilized by the first and second users 101, 115 to interact with any device in the system 100, any network in the system 100, or any combination thereof. For example, the software applications executing on the first, second, third, fourth, and fifth user devices 102, 106, 110, 116, 120 may be applications for controlling the robotic capsule filling machine 125 and/or the system 100, receiving capsule formulation inputs, or a combination thereof. In certain embodiments, the first, second, third, fourth, and fifth user devices 102, 106, 110, 116, 120 may include associated telephone numbers, internet protocol addresses, device identities, or any other identifiers to uniquely identify the first, second, third, fourth, and fifth user devices 102, 106, 110, 116, 120.

As indicated above, the system 100 may include a robotic capsule filling machine 125. The robotic capsule filling machine 125 may be a robotic device that is configured to fill one or more capsules based on a desired capsule formulation provided to the robotic capsule filling machine 125. In certain embodiments, the robotic capsule filling machine 125 may include a variety of components to enable operation of the robotic capsule filling machine 125 and to facilitate the capsule filling process. For example, the robotic capsule filling machine 125 may include a hood 126, a robotic arm 127, a bed 202, a bed adaptor 205, a capsule tray apparatus 128, one or more reservoirs 129, one or more tip pack trays 220, one or more handles 250, one or more ports 260, an emergency stop button 270, one or more motors, one or more memories to store instructions and data of the system 100, one or more processors to execute instructions from the memory, any other components, or any combination thereof. The robotic capsule filling machine 125 may also include one or more transceivers, network chips, or other communications equipment to enable robotic capsule filling machine 125 to communicate with other devices in the system 100. The hood 126 of the robotic capsule filling machine 125 may be made of any suitable material, such as, but not limited to, plastic, metal, and/or any other suitable material. Illustratively, the hood 126 is shown as being transparent. The handle 250 may be connected to the hood 126 of the robotic capsule filling machine 125 so as to move the hood 126 up to enable access to the internals of the robotic capsule filling machine 125 or to move the hood 126 down so as to prevent access to the internals of the robotic capsule filling machine 125. In certain embodiments, the hood 126 may include one or more openings so as to enable a user, such as first user 101 to access portions of the robotic capsule filling machine 125 via the openings. In certain embodiments, the hood 126 may include any number of sensors, which may be utilized to transmit signals indicating whether the hood 126 is open and/or whether the hood 126 is closed. In certain embodiments, the sensors may be configured to transmit a signal to the first, second, third, fourth and fifth user devices 102, 106, 110, 116, 120 alerting the first or second user 101, 115 regarding the hoods 126 position.

The robotic arm 127 of the robotic capsule filling machine 125 may be the component of the system 100 that may be utilized to attach to one or more tips 225 and extract one or more ingredients 1302 for a capsule formation from one or more reservoirs 129 using the tips 225. In certain embodiments, the robotic arm 127 may be secured to a first robot arm track 235 and to a second robot arm track 405. Upon receiving signals or instructions from the system 100, the robotic arm 127 may move along first robot arm track 235, which may correspond to the x-axis. The robotic arm 127 may move along the first robot arm track 235 so as to change the position of the robotic arm 127 within the robotic capsule filling machine 125. Additionally, the robotic arm 127 may be configured to move up and down within the robotic capsule filling machine 125, which may correspond to the z-axis. The x-axis and z-axis movements of the robotic arm 127 may facilitate attaching tips 225 to the robotic arm 127, picking up ingredients 1302 from the reservoirs 129, and dispensing the ingredients 1302 into the bottom portions (e.g. bottom halves) of one or more capsules 303. In certain embodiments, the robotic arm 127 of the robotic capsule filling machine 125 may include a head portion 230 including a cassette or cartridge. The cassette or cartridge may house a plurality of pistons that are covered by a plurality of engagers 310, which may be configured to attached to a plurality of tips 225, such as via an interference fit. The tips 225 may include a volume in which one or more ingredients may be contained. The pistons may be the component of the head portion 230 of the robotic arm 127 that may be utilized to extract ingredients from the reservoirs using the tips 225, and then dispense the ingredients from the tips 225 into one or more capsules.

The robotic capsule filling machine 125 may include a bed 202, which may be designed to conform to the Society for Laboratory Automation and Screening (SLAS) standards or any other standards. The bed 202 may reside within the robotic capsule filling machine 125 may be configured to move forwards and backwards (i.e. y-axis perspective) within the robotic capsule filling machine 125 via one or more bed tracks 502 on a base portion of the robotic capsule filling machine 125. In certain embodiments, the bed may be configured to move forwards and backwards by utilizing a motor embedded within the robotic capsule filling machine 125. In certain embodiments, the bed 202 may be configured to detach from the robotic capsule filling machine 125 when necessary, such as for cleaning purposes or to make adjustments.

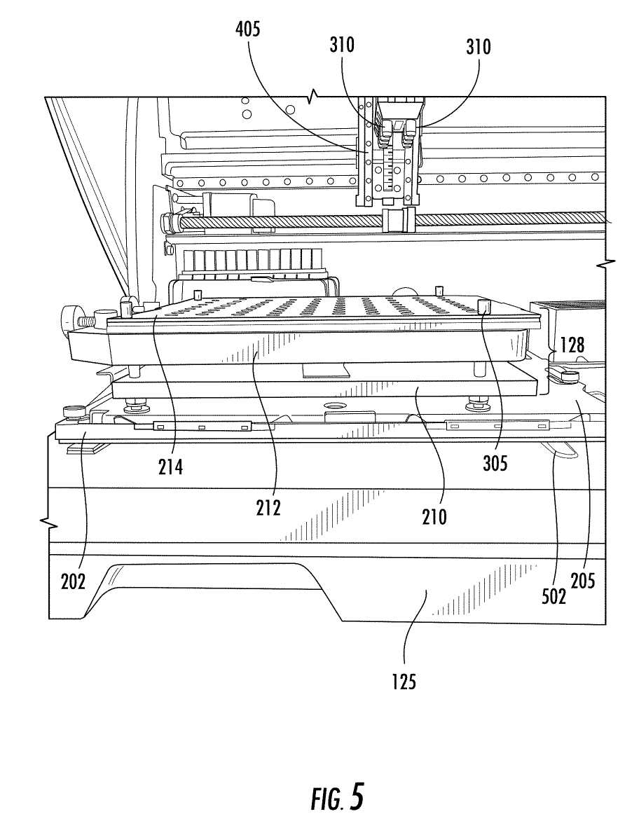

The bed 202 of the robotic capsule filling machine 125 may include a plurality of bed slots 203 or spaces, which may serve as receptacles for receiving various types of components of the robotic capsule filling machine 125. For example, the bed slots 203 may be configured to receive and connect with reservoirs 129, tip pack trays 220, or any other desired component. In FIGS. 2-18, the bed 202 is illustratively shown as having nine, generally rectangular-shaped bed slots 203 (four of the bed slots 203 lie beneath bed adaptor 205), however, any number of bed slots 203 having any size or shape may be utilized with the bed 202. In certain embodiments, one or more of the bed slots 203 may be configured to connect with a particular component of the robotic filling capsule machine 125. For example, the bed adaptor 205 of the robotic capsule filling machine 125 may be configured to occupy four of the bed slots 203 of the robotic capsule filling machine 125 at once. In FIGS. 2-18, the bed adaptor 205 is illustratively shown as occupying and being attached to the group of four bed slots 203 located at the front-left side of the robotic capsule filling machine 125. This may be done to provide maximum efficiency between capsule fillings performed by the robotic capsule filling machine 125. At this position, capsule tray apparatus 128 may travel the smallest amount of distance necessary to fill each capsule as the bed 202 is moved by the robotic capsule filling machine 125, thereby maximizing output capacity. In certain embodiments, the bed adaptor 205 may be sized and shaped to be attached to any number of the bed slots 203 or to any group of bed slots 203 of the robotic capsule filling machine 125. In certain embodiments, the bed adaptor 205 may be secured to the bed 202 by utilizing any number of pins 804, fastening mechanisms, clips 802, or a combination thereof. The bed adaptor 205 may also include a plurality of bed adaptor slots 602 through which a plurality of pins 305 may be inserted so as to secure the bed adaptor 205 to the capsule tray apparatus 128. The pins 305 may be utilized to secure the capsule tray apparatus 128 to the bed adaptor 205 of the robotic capsule filling machine 125. This is illustratively shown in FIGS. 4-9.

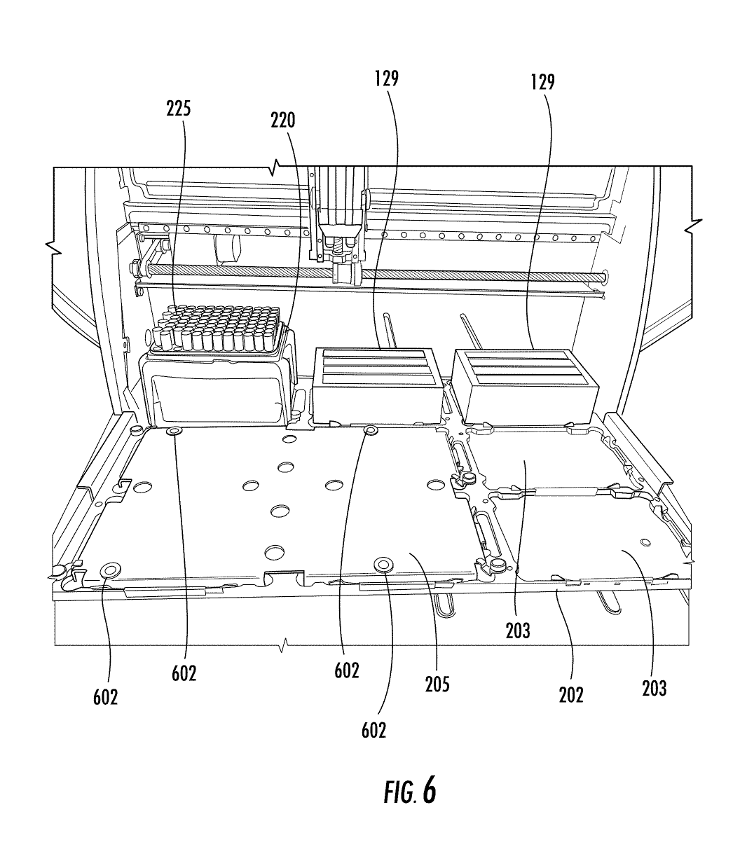

The capsule tray apparatus 128 of the robotic capsule filling machine 125 may include a plurality of components. As shown in FIG. 5, the portions of the capsule tray apparatus 128 may include a rejoining plate 210, a capsule tray body 212, and a capsule aligner 214. The rejoining plate 210 may be made of acrylic materials or any other suitable materials and may be moved upwards towards the capsule tray body 212 of the capsule tray apparatus 128 or downwards and away from the capsule tray body 212. In certain embodiments, the rejoining plate 210 may be utilized to join the bottom halves of capsules 303 with the top halves of capsules 283 when the rejoining plate 210 is moved upwards towards the capsule tray body 212 and when the capsule holder 280 is placed on top of the capsule tray apparatus 128. The rejoining plate 210 may be secured to the capsule tray apparatus 128 and to the robotic capsule filling machine 125 via the pins 305. The pins 305 may be configured to position through holes positioned in the corners of the rejoining plate 210. The capsule tray body 212 may be configured to reside between the rejoining plate 210 and the capsule aligner 214 and may also be secured to the capsule tray apparatus 128 and to the robotic capsule filling machine 125 via the pins 305, which may be inserted through holes positioned on the corners of the capsule tray body 212. In certain embodiments, the capsule tray body 212 may be made of any suitable materials, such as, but not limited to, metal or other types of materials.

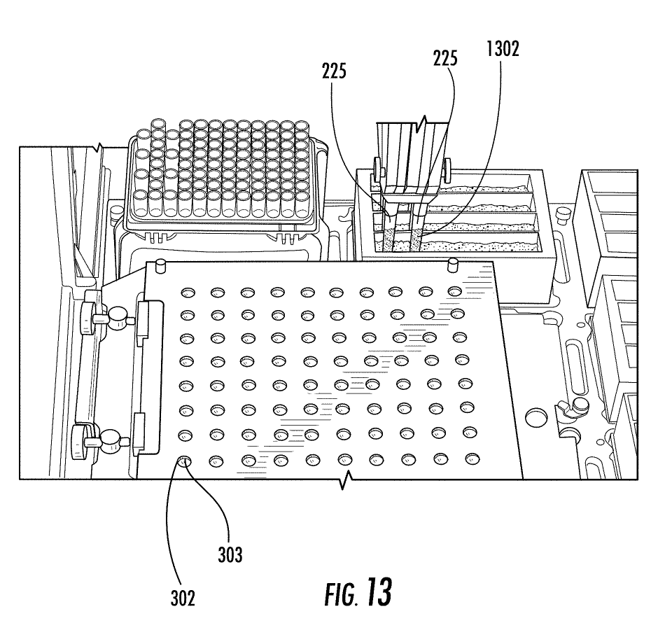

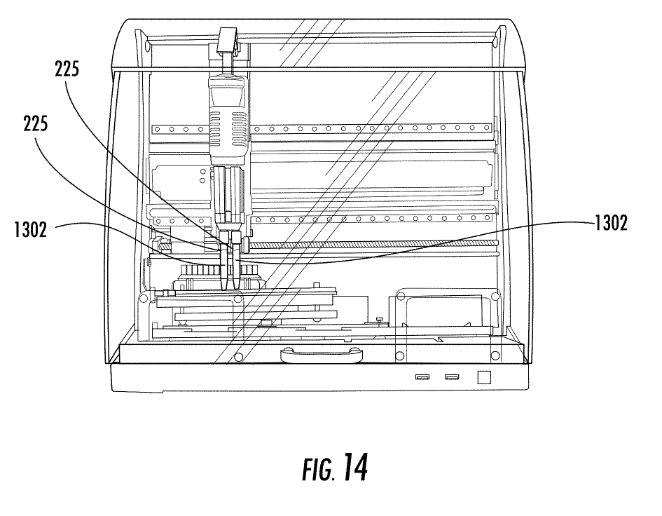

The capsule aligner 214 of the capsule tray apparatus 128 may be configured to reside on top of the capsule tray body 212 and may be configured to include a plurality of capsule slots 302, through which the bottom portions of a plurality of capsules 303 may be inserted and placed into. For example, FIGS. 12-13 illustrate the bottoms halves of capsules 303 resting within the capsule slots 302 of the capsule aligner 214. In certain embodiments, the distance between each capsule slot 302 may be nine millimeters to allow for a multiple capsule dispense from the robotic arm 127, however, in other embodiments, the distance between each capsule slot 302 may be any other desired distance. The capsule aligner 214 may be secured to the capsule tray apparatus 128 via the pins 305, which may be inserted through holes positioned on the corners of the capsule aligner 214, which is shown in FIGS. 2-5. As a result, the pins 305 may be configured to connect the capsule aligner 214, the capsule body 212, and the rejoining plate 210 together and also to the bed 202 of the robotic capsule filling machine 125. In certain embodiments, the pins 305 may be utilized by the robotic capsule filling machine 125 to interpret the specific capsule slots 302 on the capsule tray apparatus 128. In certain embodiments, the pins 305 may be utilized to rejoin the bottom halves of capsules 303 to the top halves of the capsules 283 after the bottom halves of the capsules 303 have been filled by the robotic capsule filling machine 125. In certain embodiments, the components of the capsule tray apparatus 128 may be secured to one another and/or the positions of the components of the capsule tray apparatus 128 may be set by utilizing the adjusters 216. In certain embodiments, the adjusters 216 may be turned in one direction to secure the capsule tray apparatus 128 to the robotic capsule filling machine 125, and the adjusters 216 may turned in another direction so that the capsule tray apparatus 128 may be lifted off of the robotic capsule filling machine 125.

As indicated above and as shown in FIG. 2, the system 100 may include a capsule holder 280. The capsule holder 280 may be configured to hold the top halves of a plurality of capsules 283 within a plurality of capsule holder slots 282 of the capsule holder 280. In certain embodiments, the capsule holder 280 may include a protective cover 284, which may be utilized to cover the top halves of the capsules 283 so as to protect them. Additionally, the capsule holder 280 may include one or more handles 286 so that the first or second user 101, 115 can easily lift and/or carry the capsule holder 280 from one location to another. After the bottom halves of the capsules 303 are filled by the robotic capsule filling machine 125, the first or second user 101, 115 can lift the hood 126 and can detach and remove the capsule tray apparatus 128 from the robotic capsule filling machine 125. The first user or second user 101, 115 may then place the capsule holder 280 containing the top halves of the capsules 283 on top of the capsule aligner 214 so that the tops halves of the capsules 283 are aligned on top of the bottom halves of the capsules 303 and the pins 305 go into the holes 287 located in proximity to the corners of the capsule holder 280. Then, the first user or second user 101, 115 may exert pressure down on the capsule holder 280 and lift up the rejoining plate 210 to seal the bottom halves of the capsules 303 to the top halves of the capsules 283 to create fully formed capsules. In certain embodiments, instead of taking the capsule tray apparatus 128 out of the robotic capsule filling machine 125 to seal the capsules, the first or second user 101, 115 may place the capsule holder 280 on top of the capsule tray apparatus 128 after the bottom halves of the capsules 303 are filled. In such embodiments, the robotic capsule filling machine 125 may adjust the capsule aligner 214 upwards and exert pressure down on the capsule holder 280 so that the bottom and top halves of the capsules 303, 283 are sealed together.

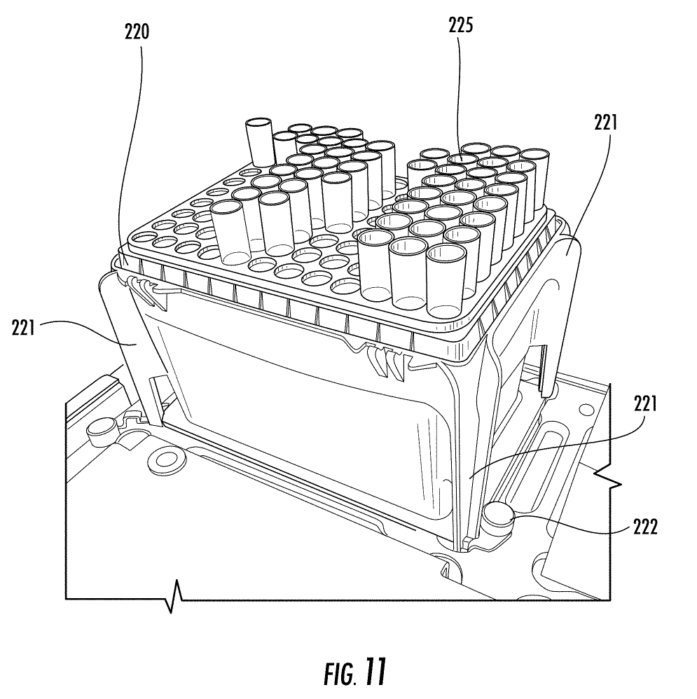

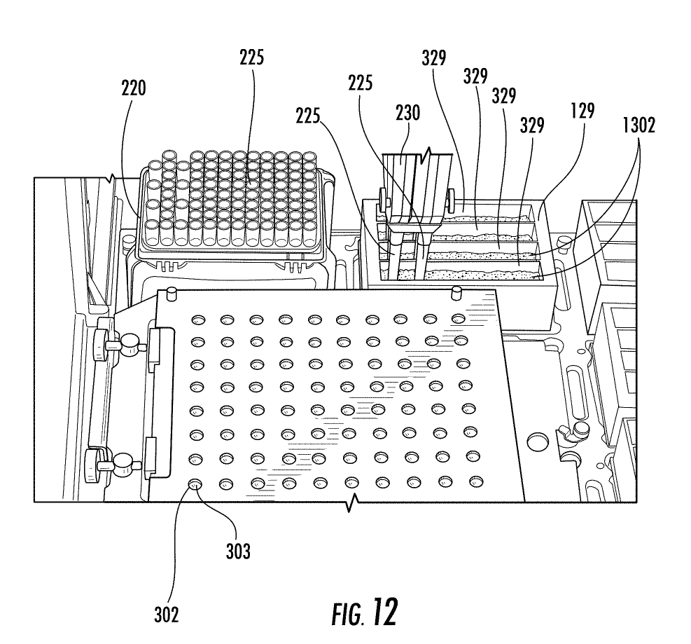

The robotic capsule filling machine 125 of the system 100 may also include one or more tip pack trays 220. The tip pack trays 220 may be configured to have multiple slots through which tips 225 may be inserted. In certain embodiments, a tip pack tray 220 may include one or more legs 221. Illustratively, in FIGS. 2-6, 11-16 and 18, the tip pack tray 220 includes four legs 221 positioned on the corners of the tip pack tray 220, however, any number of legs 221 may be utilized. The tip pack tray 220 may be configured to attach to the robotic capsule filling machine 125. To that end, a tip pack tray adaptor 702 may be secured to the bed 202 via one or more pins 222, which may be turned in one direction to secure the tip pack tray adaptor 702 to the bed 202 or turned in a different direction to release the tip pack tray adaptor 702 from the bed 202. Illustratively, two pins 222 are shown, which are positioned at opposing corners, and the tip pack tray adaptor 702 is secured to a bed slot 203 located at the rear left corner of the bed 202. As shown in FIGS. 10-11, a portion of each of the four legs 221 may be configured to be inserted into slots 223 located just beyond the corners of the tip pack tray adaptor 702 so as to secure the tip pack tray 220 to the bed 202 of the robotic capsule filling machine 125.

The tips 225 may be any kind of tip that may be configured to include a volume capable of holding one or more ingredients, solutions, liquids, substances, or a combination thereof. In certain embodiments, the tips 225 may be pipettes or any other similar devices for transporting, extracting, and/or dispensing one or more ingredients, solutions, liquids, substances, or a combination thereof. In certain embodiments, the tips 225 may be made of plastic, however, any suitable material may be utilized with the system 100. While the robotic capsule filling machine 125 is operating, the robotic arm 127 may be configured to lower down towards the tip pack tray 220 so that the engagers 310 may connect to the top portions of the tips 225. Once the tips 225 are connected to the robotic arm 127, the robotic arm 127 may move towards one or more reservoirs 129 so that one or more ingredients 1302 may be extracted from the reservoirs 129 and directed into the tips 225.

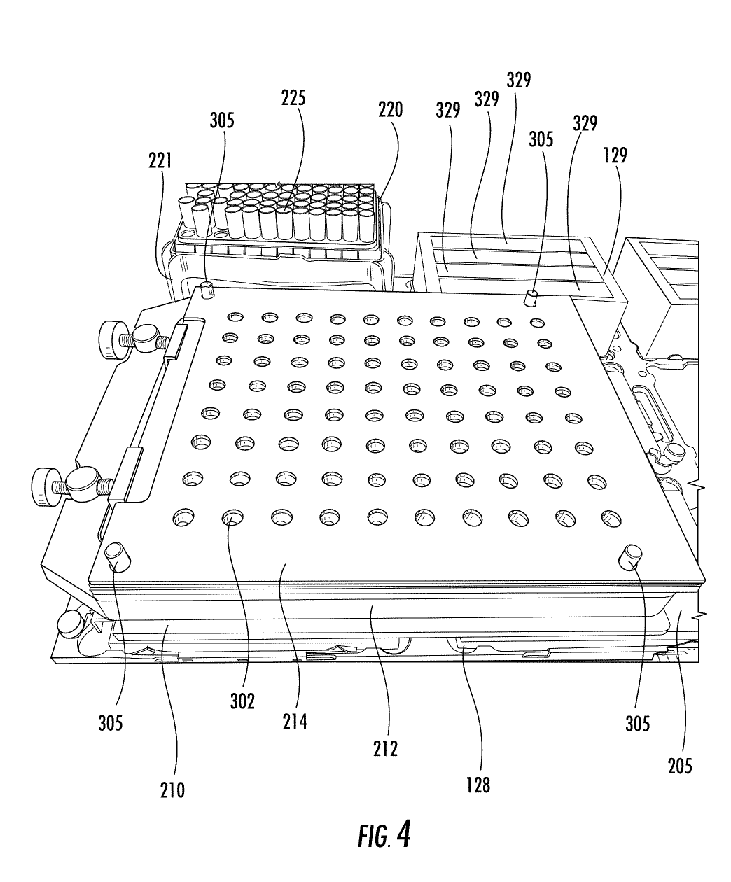

As indicated herein, the robotic capsule filling machine 125 of the system 100 may include one or more reservoirs 129. Each reservoir 129 may be configured to be secured to a bed slot 203 of the bed 202. For example, in FIG. 3, a first reservoir 129 is secured to the back center bed slot 203 and a second reservoir 129 is secured to the back right bed slot 203 of the bed 202. Notably, any number of reservoirs 129 may be utilized with the robotic capsule filling machine 125. Each reservoir 129 may include one or more reservoir slots 329. For example, in FIG. 3, the two reservoirs 129 each include four reservoir slots 329. Each of the reservoir slots 329 may be configured to store the same ingredient 1302, solution, oil, or other substance, however, in certain embodiments, each reservoir slot 329 may contain a different ingredient 1302, solution, oil, or other substance. During operation, the robotic arm 127 of the robotic capsule filling machine 125 may be configured to position over one or more of the reservoirs 129. Once positioned over a particular reservoir 129, the robotic arm 127 may move lower so that tips 225 attached to the robotic arm 230 of the robotic capsule filling machine 125 may descend into one or more reservoir slots 329. Once a particular tip 225 has descended into one of the reservoir slots 329, the robotic capsule filling machine 125 may cause one or more ingredients within a particular reservoir slot 329 to be extracted into a tip 225. In certain embodiments, the tip 225 may be configured to extract ingredients from any number of reservoir slots 329 depending the type of capsule formulation to be filled in a particular batch of capsules.

In certain embodiments, the robotic capsule filling machine 125 may include one or more ports 260. The ports 260 may be any type of port. For example, the ports 260 may be universal serial bus (USB) ports, lightning ports, any type of data port, any type of power port, any type of communication port, or any combination thereof. For example, in certain embodiments, the port 260 may be a USB port, which may be configured to connect with a flash drive, a computing device, a data storage device, or other device that has a USB connector capable of connecting with the port 260. Software updates for updating software for controlling the robotic capsule filling machine 125 may be received from one or more devices via the ports 260. Additionally, recalibration operations for recalibrating various components and functionality of the robotic capsule filling machine 125 may be received, modified, or deleted by receiving instructions from a device connected to the ports 260. Furthermore, specifications indicating a manner in which the robotic capsule filling machine is to operate may also be received from one or more devices connected to the ports 260. In certain embodiments, any information or history related to the operation of the robotic capsule filling machine 125 may be transferred from the robotic capsule filling machine 125 to a device connected to one or more of the ports 260. Additionally, specifications corresponding to the robotic capsule filling machine 125 may also be transmitted from the robotic capsule filling machine 125 to a device connected to one or more of the ports 260. In certain embodiments, the robotic capsule filling machine 125 may also include button 270. In certain embodiments, the button 270 may be an emergency override button, which may be utilized to override any instructions received by the robotic capsule filling machine 125. In certain embodiments, the button 270, when pressed, may cause the robotic capsule filling machine 125 to shut down, halt operations, or a combination thereof.

The system 100 may also include a communications network 135. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry, and may be controlled by a service provider. The communications network 135 may also include and be connected to a cloud-computing network, an IMS network, a VoIP network, a VoLTE network, a wireless network, an Ethernet network, a satellite network, a broadband network, a cellular network, a private network, a cable network, the Internet, an internet protocol network, a multiprotocol label switching (MPLS) network, a content distribution network, any network, or any combination thereof. Illustratively, servers 140 and 150 are shown as being included within communications network 135.

Notably, the functionality of the system 100 may be supported and executed by using any combination of the servers 140, 150, and 160. The servers 140, and 150 may reside in communications network 135, however, in certain embodiments, the servers 140, 150 may reside outside communications network 135. The servers 140, and 150 may be utilized to perform the various operations and functions provided by the system 100, such as those requested by applications executing on the first, second, third, fourth, and/or fifth user devices 102, 106, 110, 116, 120. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 150 may include a memory 151 that includes instructions, and a processor 152 that executes the instructions from the memory 151 to perform the various operations that are performed by the server 150. In certain embodiments, the servers 140, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 150 may be communicatively linked to the communications network 135, any network, any device in the system 100, or any combination thereof.

The database 155 of the system 100 may be utilized to store and relay information that traverses the system 100, cache information and/or content that traverses the system 100, store data about each of the devices in the system 100, and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or be connected to a processor and memory to perform the various operation associated with the database 155. In certain embodiments, the database 155 may be connected to the robotic capsule filling machine 125, the servers 140, 150, 160, the first user device 102, the second user device 106, the third user device 110, the fourth user device 116, the fifth user device 120, any devices in the system 100, any other device, any network, or any combination thereof.

The database 155 may also store information and metadata obtained from the system 100, store metadata and other information associated with the first and second users 101, 115, store user profiles associated with the first and second users 101, 115, store device profiles associated with any device in the system 100, store communications traversing the system 100, store user preferences, store information associated with any device or signal in the system 100, store information relating to patterns of usage relating to the first, second, third, fourth, and fifth user devices 102, 106, 110, 116, 120, store any information obtained from any of the networks in the system 100, store historical data associated with the first and second users 101, 115, store device characteristics, store information relating to any devices associated with the first and second users 101, 115, store any information associated with the robotic capsule filling machine 125, store log on sequences and/or authentication information for accessing any application that is utilized to control the robotic capsule filling machine 125, or any combination thereof. In certain embodiments, the database 155 may also be configured to store capsule formulations made by the first and/or second users 101, 115, store specifications corresponding to the robotic capsule filling machine 125, store a job history for capsule filling jobs performed by the robotic capsule filling machine 125, store information corresponding to errors that the robotic capsule filling machine 125 experiences or causes during operation or otherwise, store information identifying the type of tips 225 utilized, store information relating to the reservoirs 129, store information generated or received by the applications utilized for controlling the robotic capsule filling machine 125, store simulations for jobs to be performed by the robotic capsule filling machine 125, store a history of purchases made using the shopping cart button 3202, store a history indicating which capsule formulations were invalidated, store information indicating the model of the robotic capsule filling machine 125, store information indicating the version of software being utilized to control the robotic capsule filling machine 125, or any combination thereof. In certain embodiments, the database 155 may be configured to store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

Operatively, the robotic capsule filling machine system 100 may operate as shown in the following exemplary scenarios. In a first example scenario, the first user 101 may be a machine operator of the robotic capsule filling machine 125 and may desire to create one or more capsule formulations to be dispensed into various batches of capsules. The second user 115 may be an administrator who oversees the functioning of the robotic capsule filling machine 125, handles errors occurring in the system 100, sends software updates for software controlling the robotic capsule filling machine 125, receives purchase orders entered via the shopping cart button 3202, performs any type of administrative function, or any combination thereof. The first user 101 may utilize the third user device 110 to communicate with the robotic capsule filling machine 125 and to communicate with other components and devices of the system 100. In this scenario, the third user device 110 may be a tablet device. An application for controlling the robotic capsule filling machine 125 may execute on the third user device 110 and the first user 101 may open the application while using the third user device 110.

Once the first user 101 opens the application on the third user device 110, a graphical user interface for the application may be displayed on the interface 113 of the third user device 110. Example graphical user interface screens are schematically illustrated in FIGS. 19-39. In certain embodiments, the graphical user interface may allow the first user 101 to select between a simple mode of operating the robotic capsule filling machine 125 or an advanced mode for operating the robotic capsule filling machine 125. If the first user selects the option to proceed with the simple mode, graphical user interface screen 1900 may be displayed on the interface 113 of the third user device 110, as shown in FIG. 19. While in simple mode, the application may allow the first user 101 to select one or more inputs associated with a capsule formulation to be dispensed into one or more capsules. These inputs may include, but are not limited to, a capsule size input, a dosage input, a purity input, a density input, and a batch size input. The capsule size may correspond with various possible capsule sizes for use with the robotic capsule filling machine 125. For example, in FIG. 19, the possible capsule sizes include 4, 3, 2, 1, 0, 0E, 00, 00E, and 000, however, any types of capsule sizes may be utilized. In certain embodiments, the capsule sizes may include capsule size 5 or other desired capsule sizes. The heights of the capsule sizes may be measured in centimeters, however, other forms of measurement may be utilized. At screen 1900, the first user 101 may opt to select capsule size 0 by selecting on the visual representation of capsule size 0 displayed in the screen 1900.

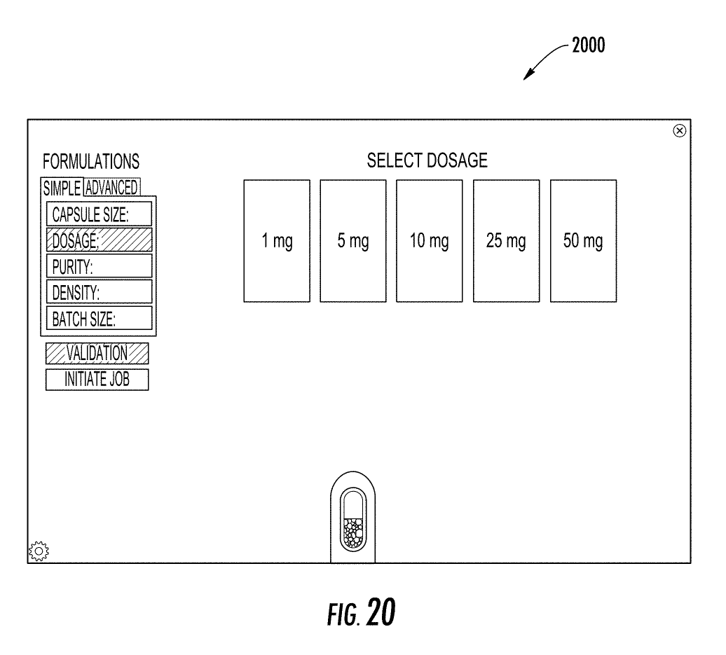

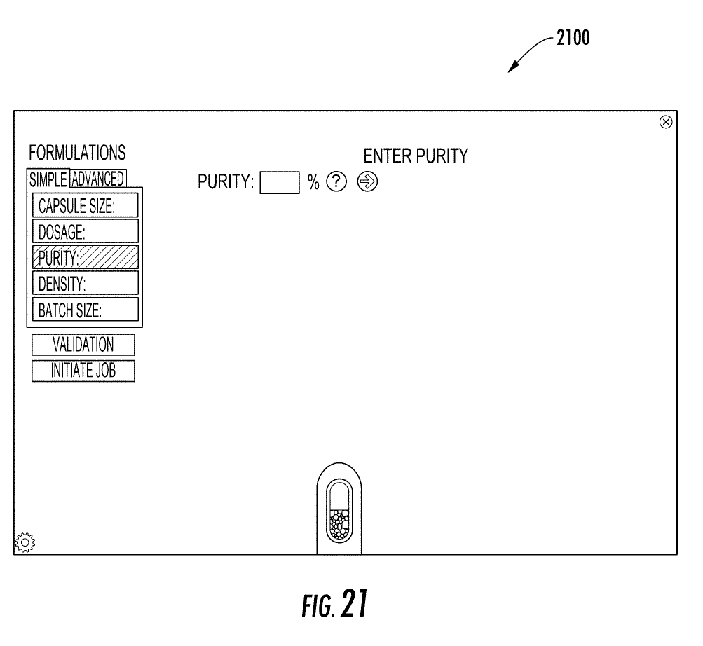

Once the capsule size selection is made, the first user 101 may be presented with graphical user interface screen 2000 on the third user device 110, as shown in FIG. 20. Screen 2000 illustrates exemplary dosages that may be selected by the first user 101. The dosage values may correspond with the amount of active ingredient in milligrams (or other appropriate metric) to be inserted into each capsule. Notably, the active ingredient may be any type of ingredient including but not limited to, vitamins, amino acids, proteins, food, medication, pharmaceutical compositions and ingredients, natural substances, artificial substances, any type of liquid, any type of solution, any type of powder, any type of substance, or any combination thereof. In FIG. 20, the possible dosage options for the active ingredient include 1 milligram, 5 milligram, 10 milligram, 25 milligram, and 50 milligram options for the active ingredient. For the purposes of this example, the first user 101 may select the 10 milligram dosage option from the screen 2000. Once the dosage is selected, the application executing on the third user device 110 may present graphical user interface screen 2100. Screen 2100 may enable the first user 101 to input a purity value for the active ingredient. The purity may be the percentage of active ingredient relative to other ingredients in the capsule formulation that is to be dispensed into each capsule. In certain embodiments, the metric may be expressed as a percentage of the total volume of ingredients and/or fill material to be dispensed into each capsule. In certain embodiments, the purity of the overall capsule formulation may take into account that at least one of the ingredients of the capsule formulation may serve as an excipient, such as an oil or other substance. For the purposes of this example, the first user 101 may select a 60% purity value to be inputted into the application.

Once the purity value is entered and submitted into the application, the application may generate and present graphical user interface screen 2200. Screen 2200 may enable the first user 101 to input a density value for the capsule formulation. The density value may be the mass of the active ingredient divided by the volume of capsule formulation to be filled into each capsule. The system 100 may utilized the density metric to convert milligrams into milliliters. For the purposes of this example, the first user 101 may enter in a density value of 1.02 g/cm³ into the application. After entering and submitting the density value through the application, the application may generate graphical user interface screen 2300, which may allow the first user 101 to enter in a batch size input into the application. The batch size may be the total amount of capsules within a given batch of capsules. For the purposes of this example, the first user 101 may enter in a batch size of 250 capsules to be produced by the robotic capsule filling machine 125. The batch size may be entered into the application, at which point, the system 100 may run a validation on the inputs to determine if the capsule formulation is feasible. In certain embodiments, the validation may be run when the first user 101 selects a validation button displayed on the graphical user interface 2300. The validation may be utilized to determine if the first user 101 is attempting to fill more than the selected capsule size can hold, for example. If the system 100 determines that the capsule formulation is not feasible, the application may output an alert or visual indication indicating that the capsule formulation is not feasible based on the inputs received by the application. For example, the application may display a red validation image that indicates that the capsule formulation is not feasible. Moreover, if the capsule formulation is not feasible, and, thus invalid, the system 100 will not allow the robotic capsule filling machine 125 to execute a run to fill the capsules. In certain embodiments, the application and/or system 100 may prevent the first user 101 from proceeding further.

If the capsule formulation is feasible, the application may generate and output graphical user interface screen 2400. Screen 2400 may display all of the inputs input by the first user 101 into the application, such as, but not limited to, the dosage, the purity, the density, the capsule size, and the batch size. In certain embodiments, the screen 2400 may present a “clear results” button which may allow the first user 101 to clear the inputs that the first user 101 initially provided to the application. Screen 2400 may also include the validation details associated with running the validation against the inputs received into the application. In certain embodiments, the validation details may include the total volume of materials required to produce the batch. For example, in screen 2400, the validation details indicate that 0.003 liters of active ingredient is required and 0.167 liters of filler material is required for the capsule formulation. The validation details may also indicate the total grams of active ingredient and the concentration of active ingredient in grams per liter. For example, in screen 2400, the validation details indicate that the total grams of active ingredient to be used with the capsule formulation is 4 grams and the concentration of active ingredient is 23.53 grams per liter. Furthermore, the validation details may also indicate the total volume to dispense per capsule, which in this case is 0.68 milliliters.

After the capsule formulation is validated, the application may allow the first user 101 to initiate the capsule filling job via the application. Once the capsule filling job is initiated, the application may generate and display graphical user interface screen 2500. In certain embodiments, screen 2500 may display a job status and may allow the first user 101 to run the job, pause the job, resume the job, and stop the job. In certain embodiments, the application may allow the first user 101 to simulate the job without actually causing the robotic capsule filling machine 125 to physically perform the capsule filling job. If the first user 101 decides to run the capsule filling job, the application may transmit a signal to the robotic capsule filling machine 125 to indicate the capsule formulation, to indicate the inputs received by the application, and to initiate the capsule filling process. Referring to FIGS. 12-17, the capsule filling machine 125 may lower the robotic arm 127 towards the tip pack tray 220 and connect one or more tips 225 to the engagers 310 of the robotic arm 127. Once the tips 225 are connected to the engagers 310, the robotic arm 127 may move towards one or more reservoirs 129 to extract active ingredients 1302 and/or filler ingredients to be utilized in the capsule formulation to be dispensed into the capsules. Once the active ingredients 1302 and/or filler ingredients are contained within the tips 225, the robotic arm 127 may position over the capsule tray apparatus 128 and the active ingredients 1302 and/or filler ingredients may be dispensed into each of the bottom halves of capsules 303 held in the capsule tray apparatus 128 according to the capsule formulation requirements. Once the bottom halves of the capsules 303 are filled, the first user 101 may remove the capsule tray apparatus 128 from the robotic capsule filling machine and may connect the capsule holder 280 holding the top halves of the capsules 283 to the top of the capsule tray apparatus 128. The first user 101 may then seal the bottom and top halves of the capsules 303, 283 by exerting pressure downwards on the capsule holder 280 and pressure upwards against the rejoining mechanism 210 of the capsule tray apparatus 128. Once the capsules are sealed and created, the first user 101 may remove the batch of capsules from the capsule tray apparatus 128 and package them. In certain embodiments, if any errors occur during the capsule filling process or otherwise, information identifying the errors may be transmitted to fourth and/or fifth user devices 116, 120 of the second user 115 so that the errors may be analyzed, corrected, and/or dealt with.

In certain embodiments, the first user 101 may also be allowed to access various settings for the application controlling the robotic capsule filling machine 125. For example, the application may generate and output graphical user interface screen 2600. Screen 2600 may indicate an internet protocol address associated with the third user device 110, an internet protocol address for the robotic capsule filling machine 125, and a user identifier for the first user 101. Additionally, the settings may allow for the loading of a file, such as an extensible markup language (XML) file, to update settings for the robotic capsule filling machine 125, update software for controlling the robotic capsule filling machine 125, or any combination thereof. In certain embodiments, one or more tests may be conducted to check the performance of the system 100 and the results may be sent to the second user 115. The application may also allow the first user 101 to save the settings as well.

In essence, during simple mode, the user is allowed to select their desired dosage of fill material to be included in a plurality of capsules to be filled and produced. Using the built-in formulation tool provided by the application and utilized by the system 100, the user may be presented with a formula output, such as via a graphical user interface of an application controlling the robotic capsule filling machine 125 of the system 100. The output simplifies the capsule formulation and dictates how much of each material or ingredient is required to produce the desired capsule dosage. Once the master mix (i.e. the mix including all the ingredients to be utilized in the capsule formulation) is created according to the software output of the application, the first user 101 can choose to either save the formula or execute the capsule formula onto the robotic capsule filling machine 125. The formulation tool eliminates any guesswork involved with creating capsule formulations and eliminates the need for a full-time chemist on staff. The system 100 may formulate, store, and execute a desired capsule formulation from the application software itself. The system 100 may allow a user, such as the first user 101, with no prior formulation experience to accurately create capsules to the appropriate and desired milligram dosage. While in simple mode, the built-in fill material calculator utilized by the application may automatically calculate the maximum volume capacity of the capsule and let the first user 101 know how much material is required to achieve the selected dosage. The application software translates the capsule size input, the dosage input, the purity input, the density input, and the batch size input into the capsule formula so that a capsule dosage will be produced according to the first user's 101 inputs.

The first user 101 may then formulate his or her master mix according to the ratio determined by a simple fill material calculator utilized by the application of the system 100. Once the properly dosed fill material has been inserted into the reservoir 129, with one simple touch on the interface 113 of the third user device 110, the first user 101 can initiate this protocol. The ease of use for the simple fill material calculator of the application is one of the most powerful features of the application software. In certain embodiments, while in simple mode, the application sets the desired capsule size as the intended total dispense volume. From this number, we are able to know how much active ingredient is required to achieve the desired dosage for the batch size selected. The simple fill material calculator accounts for the purity of the first user's fill material so that one can accurately achieve their desired dosage as indicated in the software formulation output. The output shown to the first user 101 may be the total amount of fill material, broken down into active ingredient and excipient ratios. Based on the selected capsule size, desired dosage, purity/density of the fill material, and desired batch size, the first user 101 is told the volume of master mix that is needed in order to achieve the desired dosage for the intended batch size.

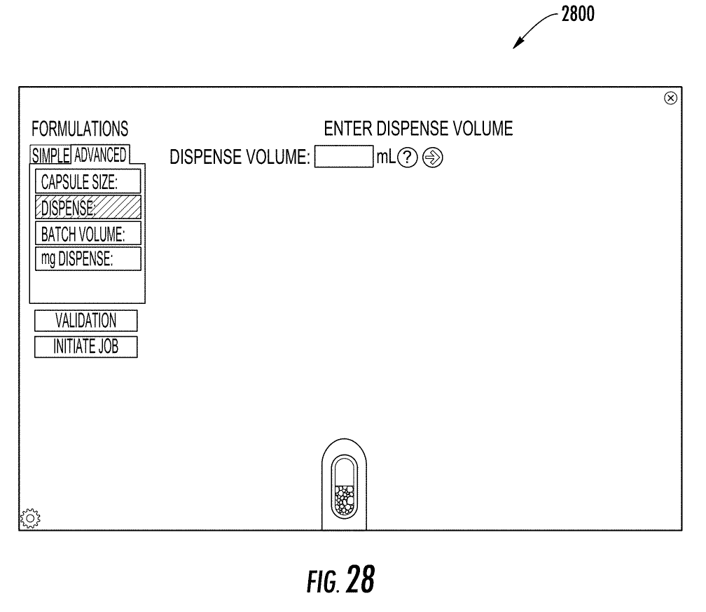

In a second example scenario, the first user 101 may opt to select the advanced mode for operating the robotic capsule filling machine 125. If the first user 101 selects the option proceed with the advanced mode, graphical user interface screen 2700 may be displayed on the interface 113 of the third user device 110, as shown in FIG. 27. While in advanced mode, the application may allow the first user 101 to select one or more inputs associated with a capsule formulation to be dispensed into one or more capsules. These inputs may include, but are not limited to, a capsule size input, a dispense input, a batch volume input, and a milligram dispense input. The capsule size may correspond with various possible capsule sizes for use with the robotic capsule filling machine 125. For example, in FIG. 27, the possible capsule sizes include 4, 3, 2, 1, 0, 0E, 00, 00E, and 000, however, any types of capsule sizes may be utilized. In certain embodiments, the capsule sizes may include capsule size 5 or other desired capsule sizes. The heights of the capsule sizes may be measured in centimeters, however, other forms of measurement may be utilized. At screen 2700, the first user 101 may opt to select capsule size 0 by selecting on the visual representation of capsule size 0 displayed in the screen 2700.

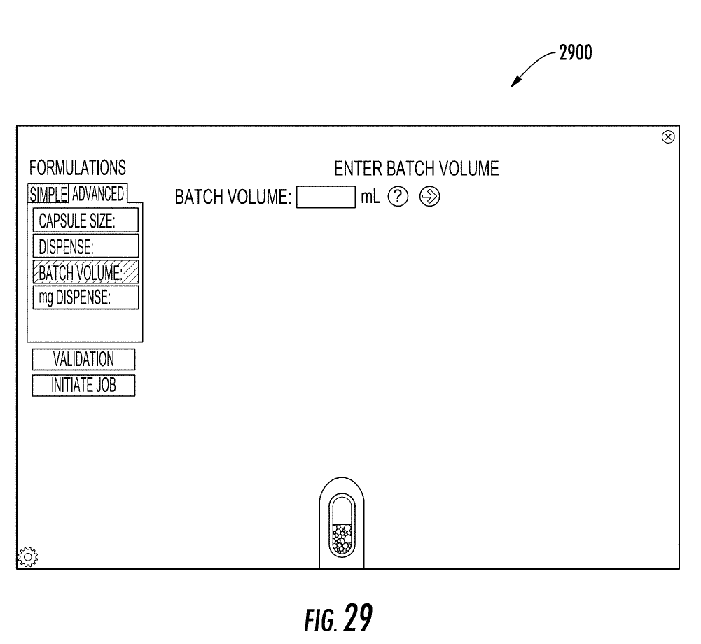

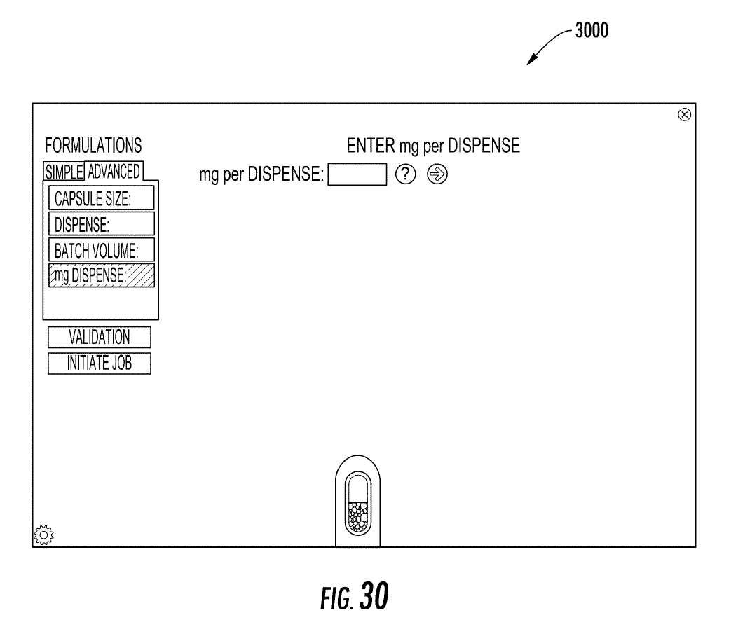

Once the capsule size selection is made, the first user 101 may be presented with graphical user interface screen 2800 on the third user device 110, as shown in FIG. 28. Screen 2800 illustrates a dispense volume field, which may be configured to receive an input from the first user 101. The dispense volume field may correspond to the amount of volume of capsule formulation to be dispensed per capsule including the active ingredient and any other ingredients, such as an excipient oil. For the purposes of this example, the first user may input 0.4 milliliters as the dispense volume in screen 2800. Once the dispense volume value is inputted into the application, the application may generate and display graphical user interface screen 2900, as shown in FIG. 29. Screen 2900 enables the first user 101 to input a batch volume in milliliters. The batch volume may correspond to the total volume of the capsule formulation in the reservoirs 129 that is to be dispensed in all of the capsules to be produced. For the purposes of this example, the first user 101 may input 100 milliliters as the batch volume. Once the batch volume is inputted in the application, the application may generate and display graphical user interface screen 3000, which allows the first user 101 to enter in a milligrams per dispense value. The milligram per dispense value may correspond to the amount of milligrams of active ingredient to be dispensed into each capsule of a batch of capsules. For the purposes of this example, the first user 101 may input 10 milligrams in the milligrams per dispense field.

Once the milligrams per dispense value is inputted into the application, the application may perform a validation check on the inputs and corresponding capsule formulation. The validation details may be generated and displayed on graphical user interface screen 3100. The validation details may display the dispense input, the batch volume input, the milligrams per dispense input, and the capsule size input received by the application. The screen 3100 may allow the first user 101 to clear the values and input new values if desired. Additionally, the screen 3100 may output the total number of capsules according to the milligram per dispense value. In this example, the total number of capsules may be 240 capsules, which include 10 milligrams of active ingredient dispensed in each of the 240 capsules to be filled by the robotic capsule filling machine 125. If the capsule formulation is validated, the application may transmit a signal to the robotic capsule filling machine 125 to fill the capsules according to the capsule formulation and the inputs received into the application from the first user 101.

In essence, the advanced mode may be utilized by users who already know the active ingredient concentration to be utilized in their master mix. The advanced mode allows a user, such as first user 101, to input a variable dosage that is based on the pre-formulated concentration of their fill material. The advanced mode may include four primary inputs as opposed to the five inputs utilized in the simple mode. Instead of formulation according to the total capsule volume (i.e. a fixed formulation and dispense), the first user 101 may input his desired dispense volume for each capsule. In certain embodiments, it may be assumed that the first user 101 knows the concentration of active ingredient within a given dispense. For example, the first user 101 may know that he wants to create a 10 mg capsule with 0.28 ml of fluid instead of the set volume per given capsule size. With the inputs of capsule size, dispense volume, total batch volume, and milligrams per dispense, the first user 101 is advised of how many capsules will be produced according to the inputs provided to the application. The first user 101 may then initiate a capsule filling run accordingly.

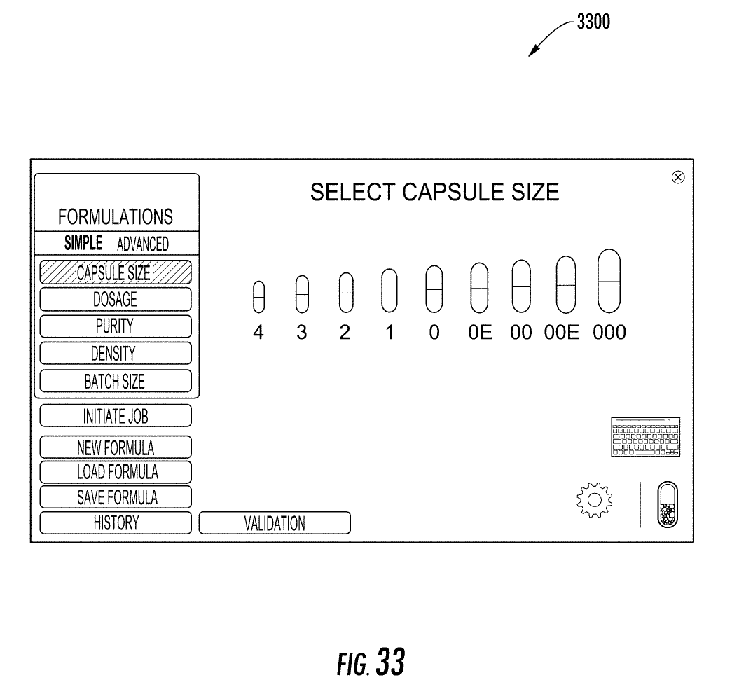

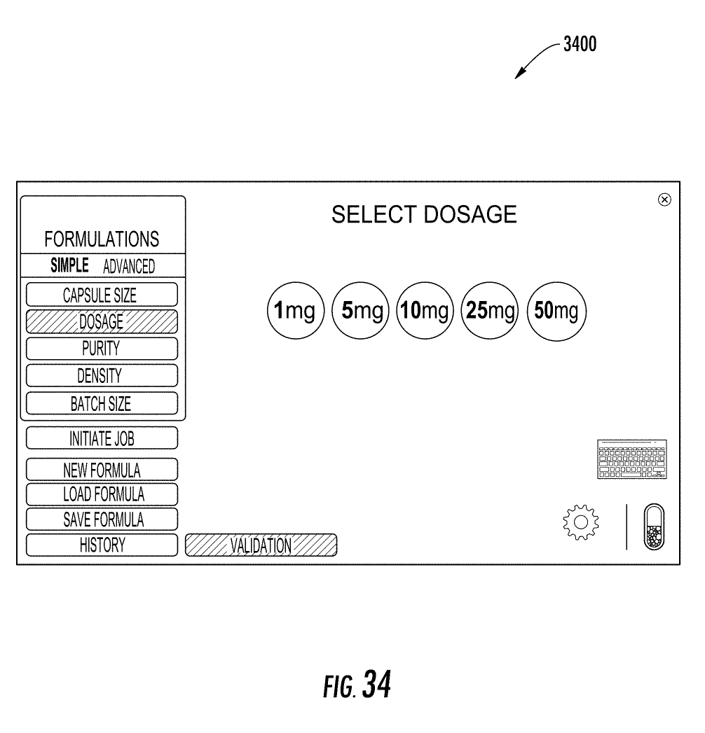

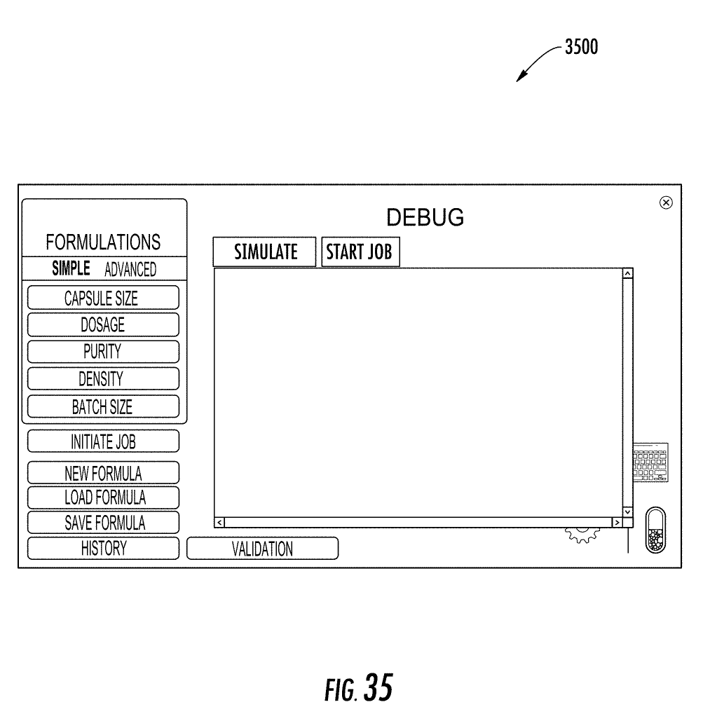

In a third example scenario, the application utilized by the first user 101 may include and support additional functionality for the system 100, as shown in FIGS. 32-39. In this example, the first user 101 may access the application and the application may generate and display graphical user interface screen 3200, as shown in FIG. 32. Screen 3200 may allow the first user 101 to select between simple mode and advanced mode. Additionally, screen 3200 may allow the first user 101 to create a new capsule formula, load a previous saved capsule formula, save a capsule formula, access a capsule formulation history, and access a shopping cart 3202 for purchasing various components and accessories for the system 100. For this example, the first user 101 may opt to proceed in simple mode, and upon receiving the simple mode selection, the application may generate and display graphical user interface screen 3300, as shown in FIG. 33. The first user 101 may then select the capsule size and the application may proceed to generate graphical user interface screen 3400, as shown in FIG. 34. The first user 101 may then select the desired dosage and the process can continue until all the inputs related to the capsule formulation are received from the first user 101. If the capsule formulation corresponding to the inputs are valid, the application can initiate the capsule filling process by transmitting a signal to the robotic capsule filling machine 125 and the capsule filling process may begin.

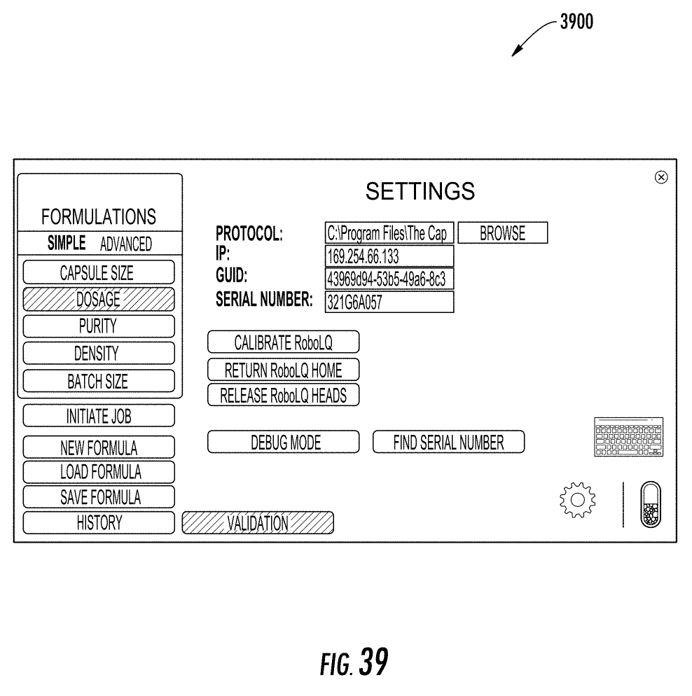

In certain embodiments, the application may present a graphical user interface screen 3500 so as to enter into a debug mode, which may be entered into by selecting a debug mode option as shown in screen 3900 of FIG. 39. The debug mode may be utilized by the second user 115, who is an administrator of the system 100. The debug mode may allow the second user 115 to view the software code being executed on the robotic capsule filling machine 125. The debug mode may enable the second user 115 to determine the cause of an error that may have occurred during the capsule filling process, an error that occurred during use of the system 100, or a combination thereof. The cause of the error may be displayed in screen 3500, along with any error details. In certain embodiments, the system 100 may transmit a notification identifying an error to the second user's 115 devices anytime an error occurs. The debug mode may be utilized to determine whether or not an error was caused by the robotic capsule filling machine 125 or by the first user 101. For example, if the robotic capsule filling machine was not calibrated properly prior to use and/or the seals on the tips 225 are not fully secured, this may mean that a machine-based error occurred. However, if two formulations are sent to the robotic capsule filling machine 125 when the robotic capsule filling machine 125 is configured to only handle one command at a time, then this may indicate a human-based error.

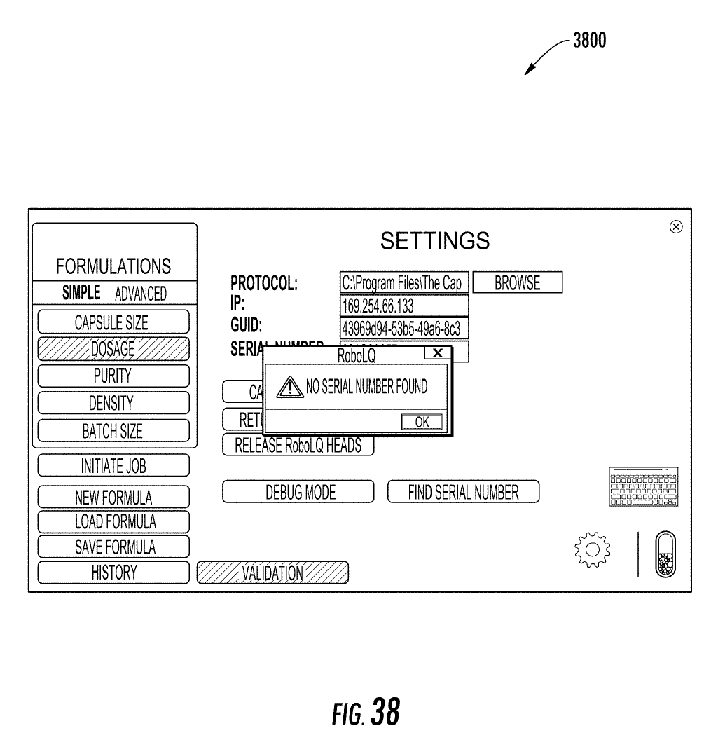

In certain embodiments, the application may generate and display graphical user interface screen 3600 when the first user 101 selects an option to view a capsule formulation history from the application. The screen 3600 may include a list of formulas previously created and executed, and include an indication as to whether a particular formula was created using simple mode or advanced mode. Additionally, screen 3600 may indicate an identifier for each run executed by the robotic capsule filling machine 125 for a particular capsule formulation, and may indicate all the inputs utilized for each capsule formulation in the history. Furthermore, the screen 3600 may indicate the date and time that a particular capsule formulation was created. In certain embodiments, the application may allow the first user 101 to create a new formula, and, once the new formula is created, the application may allow the first user 101 to save the formula into memory and/or into database 155. At a later time, the first user 101 may select an option to load a formula from the application. In response, the application may create graphical user interface screen 3700, as shown in FIG. 37. Screen 3700 displays previously created formulas that have been saved into the system 100 and the characteristics for each formula. The application may provide the option to load a formula from the list of formula shown on screen 3700, and may provide the option to delete one or more formulas.

In certain embodiments, the first user 101 may access additional settings for the application and the system 100. Referring to FIG. 38, the application may generate and display graphical user interface screen 3800, which may indicate the specific protocol being used for the system 100 and the robotic capsule filling machine 125, an internet protocol address of the robotic capsule filling machine and/or any of the devices in the system 100, a user identifier, and a serial number corresponding to the application software that a particular user is using with the system 100. The screen 3800 may provide the option to find the serial number, and, if a serial number cannot be found, the application may output an alert indicating that the serial number cannot be found. In certain embodiments, still further settings and options may be provided by the application and the system 100. For example, the application may generate and display graphical user interface screen 3900, as shown in FIG. 39. Screen 3900 may allow the first user 101 to select an option to recalibrate the robotic capsule filling machine 125, such as according to a default configuration. Additionally, screen 3900 may allow the first user 101 to select an option to return the robotic capsule filling machine 125 to a “Home” position. For example, the “Home” position may be when the robotic arm 127 is positioned above the tip pack tray 220 and towards the left back corner of the robotic capsule filling machine 125. Notably, other “Home” settings may be set as well. For example, it may be specified that the “Home” position is when the robotic arm 127 is hovering over a reservoir 129 or an empty slot 203. The screen 3900 may also allow the first user 101 to release the head portion 230 of the robotic capsule filling machine 125 as well.

Notably, the software and functionality provided by the system 100 is unique in that it is intended to be utilized by both novice and advanced users alike. The built-in algorithmic validation mechanism implemented by the system 100 will not execute a capsule filling run if the validation is not first cleared. This means that if the first user 101 attempts to fill more than the selected capsule size can hold, the system 100 will not execute the command and will present the first user 101 with an alert indicating that the validation failed. This safety protocol ensures that there is no spillage of ingredients or substances onto the internal components of the robotic capsule filling machine 125. This is a substantial problem that occurs in traditional capsule filling systems, which is solved by the system 100.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, receiving inputs corresponding to capsule formulations; translating the inputs to determine a particular capsule formulation; determining an amount of the capsule formulation to be dispensed in one or more capsules; determining if the capsule formulation is valid; preventing the robotic capsule filling machine 125 from filling capsules if the capsule formulation is invalid or for other reasons; transmitting a signal to cause the robotic capsule filling machine 125 to extract an amount of the capsule formulation from one or more reservoirs 129; causing a robotic arm 127 of the robotic capsule filling machine 125 to dispense an amount of capsule formulation into one or more capsules; causing the robotic capsule filling machine 125 to seal the capsules after the capsules have been sealed; and performing any other suitable operations conducted in the system 100 or otherwise. In one embodiment, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIGS. 1-18 illustrate specific example configurations of the various components of the system 100, the system 100 may include any configuration of the components, which may include using a greater or lesser number of the components. For example, the system 100 is illustratively shown as including a first user device 102, a second user device 106, a third user device 110, a fourth user device 116, a fifth user device 120, a robotic capsule filling machine 125, a communications network 135, a server 140, a server 150, a server 160, and a database 155. However, the system 100 may include multiple first user devices 102, multiple second user devices 106, multiple third user devices 110, multiple fourth user devices 116, multiple fifth user devices 120, multiple robotic capsule filling machines 125, multiple communications networks 135, multiple servers 140, multiple servers 150, multiple servers 160, multiple databases 155, or any number of any of the other components inside or outside the system 100. Furthermore, in certain embodiments, substantial portions of the functionality and operations of the system 100 may be performed by other networks and systems that may be connected to system 100.

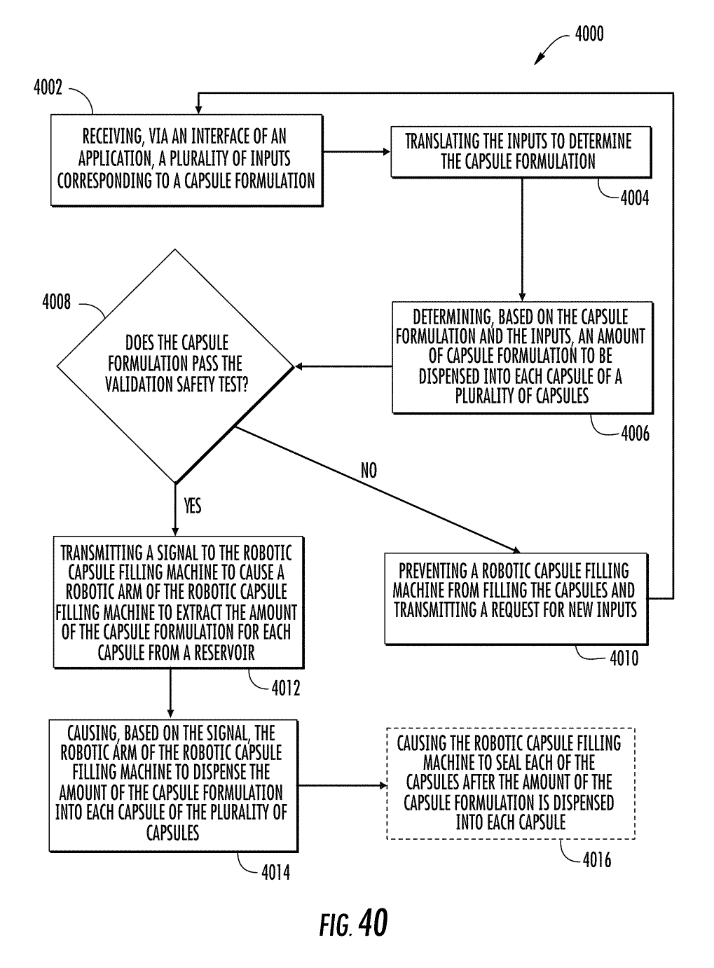

As shown in FIG. 40, an exemplary method 4000 for utilizing a robotic capsule filling machine 125 to fill capsules is schematically illustrated. The method 4000 may include steps for utilizing an application of the system 100 to control the robotic capsule filling machine 125. The method 4000 may include, at step 4002, receiving, via an interface of an application, a plurality of inputs corresponding to a capsule formulation to be dispensed in a plurality of capsules. For example, the inputs may correspond with simple mode inputs or advanced mode inputs as described herein. In certain embodiments, the inputs may be received by utilizing the first user device 102, the second user device 106, the third user device 110, the fourth user device 116, the fifth user device 120, the robotic capsule filling machine 125, the server 140, the server 150, the server 160, the communications network 135, any combination thereof, or by utilizing any other appropriate program, network, system, or device. At step 4004, the method 4000 may include translating the received inputs to determine a capsule formulation corresponding to the received inputs. In certain embodiments, the translating may be performed by utilizing the first user device 102, the second user device 106, the third user device 110, the fourth user device 116, the fifth user device 120, the robotic capsule filling machine 125, the server 140, the server 150, the server 160, the communications network 135, any combination thereof, or by utilizing any other appropriate program, network, system, or device.

At step 4006, the method 4000 may include determining, based on the capsule formulation and the received inputs, an amount of capsule formulation to be dispensed into each capsule of a plurality of capsules. In certain embodiments, the determining may be performed by utilizing the first user device 102, the second user device 106, the third user device 110, the fourth user device 116, the fifth user device 120, the robotic capsule filling machine 125, the server 140, the server 150, the server 160, the communications network 135, any combination thereof, or by utilizing any other appropriate program, network, system, or device. At step 4008, the method 4000 may include determine if the capsule formulation passes a validation safety test. For example, the validation test may determine whether the first user 101 is attempting to fill more capsule formulation into a capsule than a capsule can physically hold. In certain embodiments, the validation may be performed by utilizing the first user device 102, the second user device 106, the third user device 110, the fourth user device 116, the fifth user device 120, the robotic capsule filling machine 125, the server 140, the server 150, the server 160, the communications network 135, any combination thereof, or by utilizing any other appropriate program, network, system, or device.

If the capsule formulation and inputs do not pass the validation test, the method 4000 may proceed to step 4010. At step 4010, the method 4000 may include preventing the robotic capsule filling machine 125 from filling the capsules. Additionally, at step 4010, the method 4000 may include transmitting a request for new inputs to the first user's 101 device. In certain embodiments, the preventing and the transmitting may be performed by utilizing the first user device 102, the second user device 106, the third user device 110, the fourth user device 116, the fifth user device 120, the robotic capsule filling machine 125, the server 140, the server 150, the server 160, the communications network 135, any combination thereof, or by utilizing any other appropriate program, network, system, or device. The method 4000 can then revert back to step 4002 and proceed along the steps of the method 4000 until the capsule formulation passes the validation test. When the capsule formulation passes the validation test, the method 4000 may proceed to step 4012. At step 4012, the method 4000 may include transmitting a signal to the robotic capsule filling machine 125 to cause a robotic arm 127 of the robotic capsule filling machine to extract the determined amount of capsule formulation for each capsule from one or more reservoirs 129. In certain embodiments, the transmitting may be performed by utilizing the first user device 102, the second user device 106, the third user device 110, the fourth user device 116, the fifth user device 120, the server 140, the server 150, the server 160, the communications network 135, any combination thereof, or by utilizing any other appropriate program, network, system, or device.

Once the amount of the capsule formulation is extracted, the method 4000 may proceed to step 4014. At step 4014, the method 4000 may include causing, based on the signal, the robotic arm 127 of the robotic capsule filling machine 125 to dispense the amount of the capsule formulation into each capsule of the plurality of capsules to be produced. In certain embodiments, the causing may be performed by utilizing the first user device 102, the second user device 106, the third user device 110, the fourth user device 116, the fifth user device 120, the robotic capsule filling machine 125, the server 140, the server 150, the server 160, the communications network 135, any combination thereof, or by utilizing any other appropriate program, network, system, or device. In certain embodiments, once the capsules are filled, the first user 101 may remove the capsule tray apparatus 128 from the robotic capsule filling machine and manually seal the capsules using the capsule holder 280. In other embodiments, the method 4000 may proceed to optional step 4016. In optional step 4016, instead of having the first user 101 manually sealing the capsules, the method 4000 can include causing the robotic capsule filling machine 125 itself to seal each of the capsules after the amount of the capsule formulation is dispensed into each capsule. Notably, the method 4000 may repeated as necessary, such as when the first or second users 101, 115 desire to make new capsule formulations and new batches of capsules. Notably, the method 4000 may further incorporate any of the features and functionality described for the system 100 or as otherwise described herein.

The systems and methods disclosed herein may include additional functionality and features. For example, based on the functionality provided by the systems and methods, the back end of the software powering the system 100 may be configured to calculate the volume of ingredients and/or capsule formulation remaining within each reservoir slot 329 of a particular reservoir 129 so that an even amount of capsules is produced by the system 100. Additionally, the system 100 may automatically determine when the robotic arm 127 is to move to a next reservoir 129 to continue the filling process. This eliminates the need to manually track how much volume remains after each capsule filling cycle. In real time, the system 100 may track the capsule filling process and update a progress screen of the application to show the progress of the capsule filling process. In certain embodiments, the software will not execute a capsule filling run unless safety protocols an validations are passed. For example, the robotic capsule filling machine 125 will not operate if the hood 126 is left open. The application software powering the system 100 may control the database 155 and back end functionality. All information and analytics may be transferred to any device in the system 100 for storage. Once a particular capsule formulation is created, it may then be saved in the database 155 for future retrieval.

In certain embodiments, the robotic capsule filling machine 125 may come with a unique software package that is designed for its model type. Based on the model type of the robotic capsule filling machine 125, the software code may be adjusted to accommodate the flow of the fill material utilized for the capsules. The users of the system may select an option to upgrade the software as necessary, which may be automatically downloaded to any device that interacts with the system 100. In certain embodiments, the robotic capsule filling machine 125 may be recalibrated. In certain embodiments, the recalibration may be automatic, however, in other embodiments, the recalibration may be manual. During manual recalibration, a tool may be utilized to synchronize the bed 202 and determine the position of the respective elements and components of the bed 202. It may be synchronized with the ratio-specific reservoirs 129 to ensure that each fill material is accurately placed into each capsule according the capsule formulation inputted by a user. The recalibration feature may also be utilized when the robotic capsule filling machine is moved so as to ensure that no components shift during transport. In certain embodiments, if there is not proper suction on the tips 225, then the robotic capsule filling machine 125 may be recalibrated as well.

In certain embodiments, the robotic arm 127 may be configured to extract enough ingredients and fill material from the reservoirs 129 for eighty or more capsules or for a lesser number of capsules. In certain embodiments, in addition to using tip pack tray 220, a second empty tip pack tray 220 may be connected to one of the bed slots 203 of the bed 202. When the robotic arm 127 is done filling capsules, the robotic arm 127 may dispose the used tips 225 into the slots of the empty tip pack tray 220 to ensure clean and safe disposal of the tips 225. In certain embodiments, the robotic arm 127 may be configured to pull fill material and ingredients from multiple reservoirs at the same time. For example, one tip 225 may extract a first active ingredient from one reservoir slot 329 of a reservoir 129, and a second tip 225 may extract a second active ingredient from a different reservoir slot 320 of the reservoir 129. In certain embodiments, the system 100 may be configured to generate the capsule formulation and fill each capsule to capacity. In certain embodiments, if parts of the robotic capsule filling machine 125 malfunction or if the components are not installed properly on the robotic capsule filling machine 125, error codes may be automatically sent to the administrator for review. In certain embodiments, an error code may be sent to the administrator if a threshold amount of force is exerted on the robotic capsule filling machine 125.

In certain embodiments, the system 100 may account for fill material loss. In particular, the system 100 may extract a greater amount of ingredients (e.g. oil) than necessary from the reservoir 129 to account for any potential loss of ingredients which may occur from the time of extraction to the time of dispensing the capsule formulation into the capsules. Any fill material or ingredients left in a tip 225 after dispensing into the capsules may be dispensed back into the reservoirs 129 for future use. In certain embodiments, the robotic arm 127 may be configured to operate depending on the density of the material being used in the capsules. For example, the robotic arm 127 may be configured to move faster for thicker materials and slower for thinner materials. The robotic arm 127 may move slower for thinner materials so as to allow any air bubbles trapped in a tip 225 to move upwards within the tip 225 so as to hold the fill material in the tip 225.

The shopping cart button 3202 may be utilized by the users to order new tubing, jugs, tip pack trays 220, tips 225, bed adaptors 205, beds 202, active ingredients, oil, replacement parts, pins 305, 804, blister packaging for the packing the capsules, tip pack adaptors 702, blister sealing machines, any other components in the system 100, or any combination thereof. In certain embodiments, payment information may be stored in the system 100 and batches may be auto-ordered based on a predetermined or even random frequency. Order information may be sent to the administrator as necessary.

Notably, no matter what the concentration of the fill material, the system 100 is capable of dispensing both fixed and interval volume fill amounts. Traditional capsule filling machines require recalibration in order to run different concentrations of material, however, the system 100 solves this issue. Switching between capsule formulations using the system 100 may be accomplished with a simple touch via an application executing on a device of the system 100. The functionality provided by the system 100 is unique in that the system 100 is the only system that can account for a specific concentration of ingredients within each capsule itself. For example, the system 100 accounts for the amount of active ingredient necessary per capsule to reach the desired dosage and then formulates according to the amount of excipient oil necessary to fill each capsule. Traditional capsule filling machines simply dispense a given amount of volume and do not account for specific amounts of active ingredients. In contrast, the system 100 accounts for the amount of desired active material per capsule to accurately determine how much active material is required per capsule. The remainder of the capsule volume may be filled with excipient or other ingredients. The system 100 may further account for other desired concentrations of active materials as well. For example, the first user 101 can choose to pull two different materials from two separate reservoirs 129 and dispense a predetermined amount into the capsule. The system 100 can account for an active ingredient and other materials so that a user may select a ratio specific formulation, such as a 2:1 protein: vitamin capsule formulation, thus simplifying the formulation even further. As a result, the system 100 is provides for a smart robotic capsule filling machine 125 that is capable of both variable and fixed dispenses, learning and recalling formulations on-the-fly, while simultaneously providing an easy-to-use interface to the user.

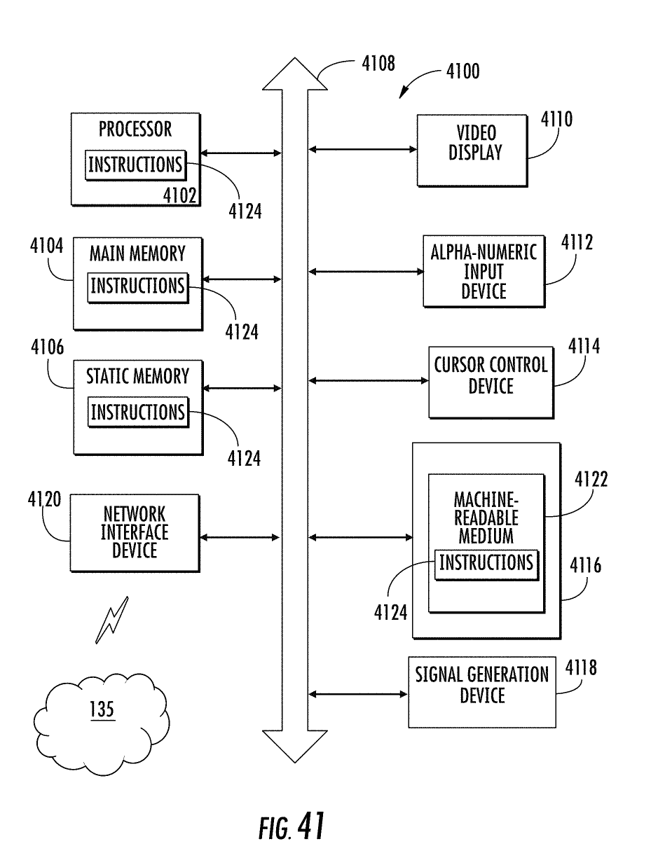

Referring now also to FIG. 41, at least a portion of the methodologies and techniques described with respect to the exemplary embodiments of the system 100 can incorporate a machine, such as, but not limited to, computer system 4100, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 106, the third user device 110, the fourth user device 116, the fifth user device 120, the robotic capsule filling machine 125, the server 140, the server 150, the database 155, the server 160, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 4100 may include a processor 4102 (e.g., a central processing unit (CPU), a graphics processing unit (GPU, or both), a main memory 4104 and a static memory 4106, which communicate with each other via a bus 4108. The computer system 4100 may further include a video display unit 4110, which may be, but is not limited to, a liquid crystal display (LCD), a flat panel, a solid state display, or a cathode ray tube (CRT). The computer system 400 may include an input device 4112, such as, but not limited to, a keyboard, a cursor control device 4114, such as, but not limited to, a mouse, a disk drive unit 4116, a signal generation device 4118, such as, but not limited to, a speaker or remote control, and a network interface device 4120.

The disk drive unit 4116 may include a machine-readable medium 4122 on which is stored one or more sets of instructions 4124, such as, but not limited to, software embodying any one or more of the methodologies or functions described herein, including those methods illustrated above. The instructions 4124 may also reside, completely or at least partially, within the main memory 4104, the static memory 4106, or within the processor 4102, or a combination thereof, during execution thereof by the computer system 4100. The main memory 4104 and the processor 4102 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 4122 containing instructions 4124 so that a device connected to the communications network 135, another network, or a combination thereof, can send or receive voice, video or data, and communicate over the communications network 135, another network, or a combination thereof, using the instructions. The instructions 4124 may further be transmitted or received over the communications network 135, another network, or a combination thereof, via the network interface device 4120.

While the machine-readable medium 4122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. An apparatus, comprising:
a robotic capsule filling machine, wherein the robotic capsule filling machine comprises:
a robotic arm and a reservoir; and
a computing device, wherein the computing devices comprises:
a memory that stores instructions;
a processor that executes the instructions to perform operations, the operations comprising:
receiving, via an interface of an application executing on the computing device, a plurality of inputs corresponding to a capsule formulation, wherein the plurality of inputs comprise a capsule size input, a dosage input, a purity input, a density input, and a batch size input;
translating the inputs to determine the capsule formulation;
determining, based on the capsule formulation and the inputs, an amount of the capsule formulation to be dispensed into each capsule of a plurality of capsules corresponding to the batch size input;
transmitting, to the robotic capsule filling machine, a signal to cause the robotic arm of the robotic capsule filling machine to extract the amount of the capsule formulation for each capsule of the plurality of capsules from the reservoir of the robotic capsule filling machine; and
causing, based on the signal and after the robotic arm of the robotic capsule filling machine extracts the amount of the capsule formulation from the reservoir, the robotic arm to dispense the amount of the capsule formulation into each capsule of the plurality of capsules.

2. The apparatus of claim 1, wherein the operations performed by the computing device further comprise transmitting, by utilizing the computing device, a signal to activate the robotic capsule filling machine.

3. The apparatus of claim 1, wherein the robotic arm of the robotic capsule filling machine further comprises a cartridge that includes an engager on which a tip is secured, wherein the tip is utilized to extract the amount of the capsule formulation for each capsule from the reservoir.

4. The apparatus of claim 1, wherein the operations performed by the computing device further comprise receiving, via the application, a debug mode input.

5. The apparatus of claim 4, wherein the operations performed by the computing device further comprise causing the robotic capsule filling machine to enter into a debug mode in response to receiving the debug mode input.

6. The apparatus of claim 1, wherein the operations performed by the computing device further comprise validating whether the capsule formulation is possible based on the plurality of inputs received.

7. The apparatus of claim 6, wherein the operations performed by the computing device further comprise preventing the robotic capsule filling machine from operating if the validating indicates that the capsule formulation is not possible based on the plurality of inputs received.

8. The apparatus of claim 1, wherein the operations performed by the computing device further comprise determining a volume of the capsule formulation that is remaining in the reservoir after the robotic arm of the robotic capsule filling machine extracts the amount of the capsule formulation for each capsule.

9. The apparatus of claim 1, wherein the operations performed by the computing device further comprise transmitting a recalibration signal to the robotic capsule filling machine to cause the robotic capsule filling machine to recalibrate itself.

10. The apparatus of claim 1, wherein the robotic arm of the robotic capsule filling machine is configured to move along a x-axis and a z-axis.

11. The apparatus of claim 1, wherein a capsule tray of the robotic capsule filling machine is configured to hold each capsule of the plurality of capsules in a plurality of capsule slots while the robotic arm dispenses the amount of the capsule formulation into each capsule.

12. The apparatus of claim 11, wherein the capsule tray of the robotic capsule filling machine resides on a bed of the robotic capsule filling machine, and is configured to move within the robotic capsule filling machine along a y-axis.

13. The apparatus of claim 1, wherein the operations performed by the computing device further comprise saving the capsule formulation into the memory of the computing device.

14. The apparatus of claim 13, wherein the operations performed by the computing device further comprise loading the capsule formulation from the memory when a load formula input is received.

15. A method, comprising:
receiving, via an interface of an application executing on a computing device, a plurality of inputs corresponding to a capsule formulation, wherein the plurality of inputs comprise a capsule size input, a dosage input, a purity input, a density input, and a batch size input;
translating, by utilizing instructions from a memory that are executed by a processor, the inputs to determine the capsule formulation;
determining, based on the capsule formulation and the inputs, an amount of the capsule formulation to be dispensed into each capsule of a plurality of capsules corresponding to the batch size input;
transmitting, to a robotic capsule filling machine, a signal to cause a robotic arm of the robotic capsule filling machine to extract the amount of the capsule formulation for each capsule of the plurality of capsules from a reservoir of the robotic capsule filling machine; and
causing, based on the signal and after the robotic arm of the robotic capsule filling machine extracts the amount of the capsule formulation from the reservoir, the robotic arm to dispense the amount of the capsule formulation into each capsule of the plurality of capsules.

16. The method of claim 15, further comprising displaying, via the computing device, validation details relating to the capsule formulation, wherein the validating details indicate a total volume of materials required for the capsule formulation, a total amount of grams of materials required for the capsule formulation, a concentration of active ingredient in grams per liter, and a volume of the capsule formulation to dispense in each capsule.

17. The method of claim 15, further comprising causing the robotic arm of the robotic capsule filling machine to secure a tip to an engager of a cartridge of the robotic capsule filling machine, wherein the tip is utilized to extract the amount of the capsule formulation for each capsule from the reservoir.

18. The method of claim 15, further comprising determining capsule locations for receiving each of the capsules on a capsule tray of the robotic capsule filling machine, wherein the capsule locations are determined based on pins connected in proximity to each corner of the capsule tray of the robotic capsule filling machine.

19. The method of claim 14, further comprising causing the robotic capsule filling machine to join a top portion of each of the capsules to a bottom portion of each of the capsules after the robotic arm dispenses the amount of the capsule formulation into each capsule of the plurality of capsules.

20. A computer-readable device comprising instructions, which when loaded and executed by a processor, cause the processor to perform operations comprising:
receiving, via an interface of an application executing on a computing device, a plurality of inputs corresponding to a capsule formulation, wherein the plurality of inputs comprise a capsule size input, a dosage input, a purity input, a density input, and a batch size input;
translating the inputs to determine the capsule formulation;
determining, based on the capsule formulation and the inputs, an amount of the capsule formulation to be dispensed into each capsule of a plurality of capsules corresponding to the batch size input;
transmitting, to a robotic capsule filling machine, a signal to cause a robotic arm of the robotic capsule filling machine to extract the amount of the capsule formulation for each capsule of the plurality of capsules from a reservoir of the robotic capsule filling machine; and
causing, based on the signal and after the robotic arm of the robotic capsule filling machine extracts the amount of the capsule formulation from the reservoir, the robotic arm to dispense the amount of the capsule formulation into each capsule of the plurality of capsules.
